(19) United States
(12) Patent Application Publication
(10) Pub. No.: US 2024/0236978 A1
(43) Pub. Date: Jul. 11, 2024

(54) METHOD AND APPARATUS FOR UPLINK TRANSMISSION IN WIRELESS COMMUNICATION SYSTEM

(71) Applicant: Samsung Electronics Co., Ltd., Suwon-si (KR)

(72) Inventors: Sa ZHANG, Beijing (CN); Feifei SUN, Beijing (CN)

(21) Appl. No.: 18/403,163

(22) Filed: Jan. 3, 2024

(30) Foreign Application Priority Data
Jan. 6, 2023 (CN) 202310021281.8
Feb. 16, 2023 (CN) 202310170058.X
Apr. 6, 2023 (CN) 202310362993.6
Apr. 14, 2023 (CN) 202310403532.9

(51) Int. Cl. H04W 72/1268; H04L 1/1812; H04W 72/0446; H04W 72/21

(52) U.S. Cl. CPC H04W 72/1268; H04L 1/1812; H04W 72/0446; H04W 72/21

(57) ABSTRACT

A method performed by a user equipment (UE) in a wireless communication system is provided. The method includes receiving first information for configuring simultaneous transmission of physical uplink shared channels (PUSCHs), second information for configuring a control resource set (CORESET) with a CORESET pool index, and third information for configuring ackNack feedback mode associated with uplink control information (UCI), identifying a PUSCH to be used for multiplexing the UCI among the PUSCHs, multiplexing the UCI in the identified PUSCH, and transmitting the PUSCHs including the identified PUSCH in which the UCI is multiplexed, wherein in case that the simultaneous transmission is enabled, the ackNack feedback mode is configured to a first mode, and the UCI includes hybrid automatic repeat request-acknowledgement (HARQ-ACK) information, the identified PUSCH is one of candidate PUSCHs selected among the PUSCHs and is associated with CORESETs.

### CROSS-REFERENCE TO RELATED APPLICATION(S)

This application is based on and claims priority under 35 U.S.C. § 119(a) of a Chinese patent application number 202310021281.8, filed on Jan. 6, 2023, in the Chinese Intellectual Property Office, of a Chinese patent application number 202310170058.X, filed on Feb. 16, 2023, in the Chinese Intellectual Property Office, of a Chinese patent application number 202310362993.6, filed on Apr. 6, 2023, in the Chinese Intellectual Property Office, and of a Chinese patent application number 202310403532.9, filed on Apr. 14, 2023, in the Chinese Intellectual Property Office, the disclosure of each of which is incorporated by reference herein in its entirety.

### BACKGROUND

### 1. Field

The disclosure relates to the technical field of wireless communication. More particularly, the disclosure relates to a method and apparatus for uplink transmission in a wireless communication system.

### 2. Description of Related Art

In order to meet the increasing demand for wireless data communication services since the deployment of 4^{th} generation (4G) communication systems, efforts have been made to develop improved 5^{th} generation (5G) or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter wave (mmWave)) bands, e.g., 60 GHZ bands. In order to reduce propagation loss of radio waves and increase a transmission distance, technologies, such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, or the like.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for uplink transmission in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving first information for configuring simultaneous transmission of physical uplink shared channels (PUSCHs), second information for configuring at least one control resource set (CORESET) with a CORESET pool index, and third information for configuring ackNack feedback mode associated with uplink control information (UCI), identifying a PUSCH to be used for multiplexing the UCI among the PUSCHs, multiplexing the UCI in the identified PUSCH, and transmitting the PUSCHs including the identified PUSCH in which the UCI is multiplexed, wherein in case that the simultaneous transmission is enabled, the ackNack feedback mode is configured to a first mode, and the UCI includes Hybrid Automatic Repeat request-Acknowledgement (HARQ-ACK) information, the identified PUSCH is one of candidate PUSCHs selected among the PUSCHs, and the identified PUSCH is associated with CORESETs which is same with CORESETs for transmission of a physical uplink control channel (PUCCH) with the HARQ-ACK information, and the PUSCHs is transmitted based on the simultaneous transmission.

In accordance with another aspect of the disclosure, a method performed by a base station in a wireless communication system is provided. The method includes transmitting, to a user equipment (UE), first information for configuring simultaneous transmission of physical uplink shared channels (PUSCHs), second information for configuring at least one control resource set (CORESET) with a CORESET pool index, and third information for configuring ackNack feedback mode associated with uplink control information (UCI), and receiving, from the UE, the PUSCHs including a PUSCH in which the UCI is multiplexed, wherein in case that the simultaneous transmission is enabled, the ackNack feedback mode is configured to a first mode, and the UCI includes Hybrid Automatic Repeat request-Acknowledgement (HARQ-ACK) information, the PUSCH is one of candidate PUSCHs selected among the PUSCHs, and the PUSCH is associated with CORESETs which is same with CORESETs for transmission of a physical uplink control channel (PUCCH) with the HARQ-ACK information, and the PUSCHs is received based on the simultaneous transmission.

In accordance with another aspect of the disclosure, a user equipment (UE) in a wireless communication system is provided. The UE includes a transceiver; and a controller coupled with the transceiver, wherein the controller is configured to: receive first information for configuring simultaneous transmission of physical uplink shared channels (PUSCHs), second information for configuring at least one control resource set (CORESET) with a CORESET pool index, and third information for configuring ackNack feedback mode associated with uplink control information (UCI), identify a PUSCH to be used for multiplexing the UCI among the PUSCHs, multiplex the UCI in the identified PUSCH, and transmit the PUSCHs including the identified PUSCH in which the UCI is multiplexed, wherein in case that the simultaneous transmission is enabled, the ackNack feedback mode is configured to a first mode, and the UCI includes Hybrid Automatic Repeat request-Acknowledgement (HARQ-ACK) information, the identified PUSCH is one of candidate PUSCHs selected among the PUSCHs, and the identified PUSCH is associated with CORESETs which is same with CORESETs for transmission of a physical uplink control channel (PUCCH) with the HARQ-ACK information, and the PUSCHs is transmitted based on the simultaneous transmission.

In accordance with another aspect of the disclosure, a base station in a wireless communication system is provided. The base station includes a transceiver; and a controller coupled with the transceiver, wherein the controller is configured to: transmit, to a user equipment (UE), first information for configuring simultaneous transmission of physical uplink shared channels (PUSCHs), second information for configuring at least one control resource set (CORESET) with a CORESET pool index, and third information for configuring ackNack feedback mode associated with uplink control information (UCI), and receive, from the UE, the PUSCHs including a PUSCH in which the UCI is multiplexed, wherein in case that the simultaneous transmission is enabled, the ackNack feedback mode is configured to a first mode, and the UCI includes hybrid automatic repeat request-acknowledgement (HARQ-ACK) information, the PUSCH is one of candidate PUSCHs selected among the PUSCHs, the PUSCH is associated with CORESETs which is same with CORESETs for transmission of a physical uplink control channel (PUCCH) with the HARQ-ACK information, and the PUSCHs is received based on the simultaneous transmission.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a schematic diagram of a wireless network according to an embodiment of the disclosure;

FIGS. 2A and 2B illustrate wireless transmission and reception paths according to various embodiments of the disclosure;

FIG. 3A illustrates a user equipment (UE) according to an embodiment of the disclosure;

FIG. 3B illustrates a gNodeB (gNB) according to an embodiment of the disclosure;

FIG. 4 illustrates a block diagram of a first transceiving node according to an embodiment of the disclosure;

FIG. 5 illustrates a block diagram of a second transceiving node according to an embodiment of the disclosure;

FIG. 6 illustrates a flowchart of a method performed by a base station according to an embodiment of the disclosure;

FIG. 7 illustrates a flowchart of a method performed by a UE according to an embodiment of the disclosure;

FIGS. 8A, 8B, and 8C illustrate uplink transmission timing according to various embodiments of the disclosure;

FIGS. 9A and 9B illustrate time domain resource allocation tables according to various embodiments of the disclosure;

FIG. 10 illustrates a flowchart of a method performed by a terminal according to an embodiment of the disclosure;

FIG. 11 illustrates a flowchart of a method performed by a base station according to an embodiment of the disclosure;

FIG. 12 illustrates a structure of a UE according to an embodiment of the disclosure; and

FIG. 13 illustrates a structure of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as read-only memory (ROM), random access memory (RAM), a hard disk drive, a compact disc (CD), a digital video disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components. Similar words, such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), or the like.

It will be further understood that similar words, such as the term “include” or “comprise” mean that elements or objects appearing before the word encompass the listed elements or objects appearing after the word and their equivalents, but other elements or objects are not excluded. Similar words, such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the disclosure can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, or the like. In addition, the technical schemes of the embodiments of the disclosure can be applied to future-oriented communication technologies.

Hereinafter, the embodiments of the disclosure will be described with reference to the accompanying drawings. It should be noted that the same reference numerals in different drawings will be used to refer to the same elements already described.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

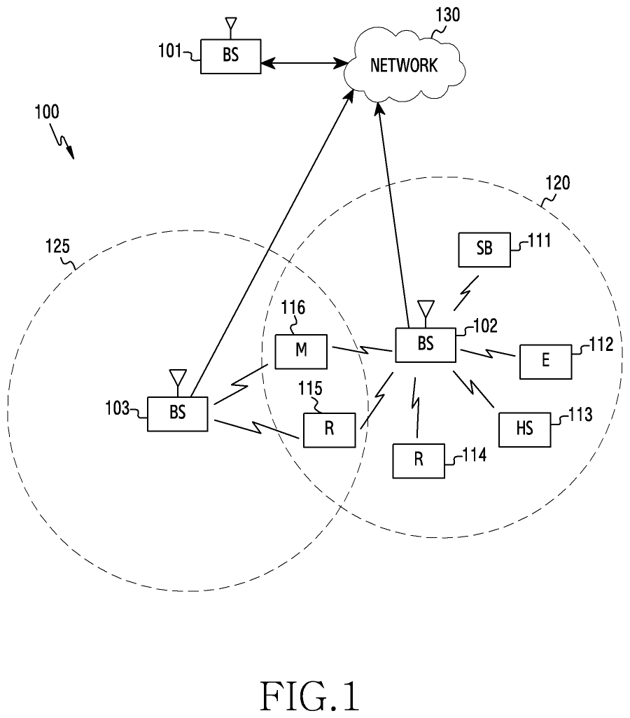

The following FIGS. 1, 2A, 2B, 3A, and 3B describe various embodiments implemented by using orthogonal frequency division multiplexing (OFDM) or orthogonal frequency division multiple access (OFDMA) communication technologies in wireless communication systems. The descriptions of FIGS. 1, 2A, 2B, 3A, and 3B do not mean physical or architectural implications for the method in which different embodiments may be implemented. Different embodiments of the disclosure may be implemented in any suitably arranged communication systems.

FIG. 1 illustrates a wireless network according to an embodiment of the disclosure.

Referring to FIG. 1, a wireless network 100 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms, such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms, such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of user equipments (UEs) within a coverage area 120 of gNB 102. The first plurality of UEs include a UE 111, which may be located in a small business (SB), a UE 112, which may be located in an enterprise (E); a UE 113, which may be located in a wi-fi Hotspot (HS), a UE 114, which may be located in a first residence (R), a UE 115, which may be located in a second residence (R), a UE 116, which may be a mobile device (M), such as a cellular phone, a wireless laptop computer, a wireless PDA, or the like, GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

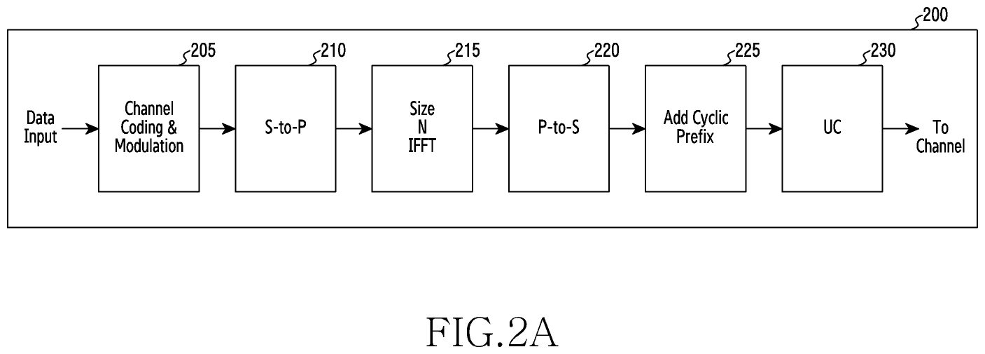

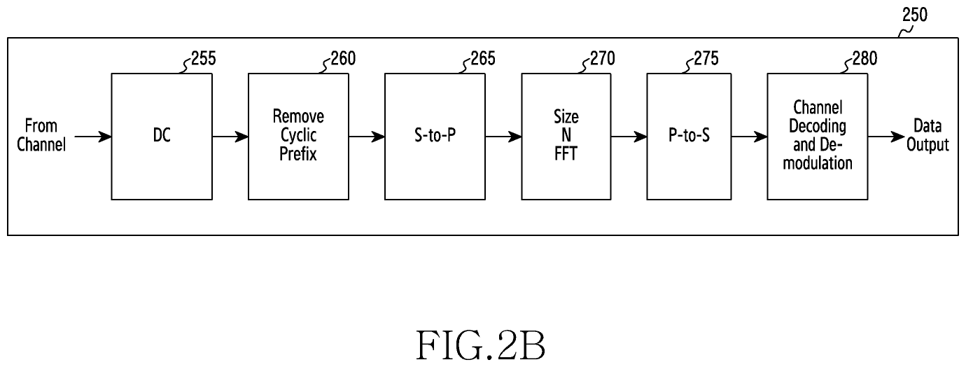

FIGS. 2A and 2B illustrate wireless transmission and reception paths according to various embodiments of the disclosure.

Referring to FIGS. 2A and 2B, a transmission path 200 can be described as being implemented in a gNB, such as gNB 102, and a reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The parallel-to-serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The serial-to-parallel block 265 converts the time domain baseband signal into a parallel time domain signal. The Size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

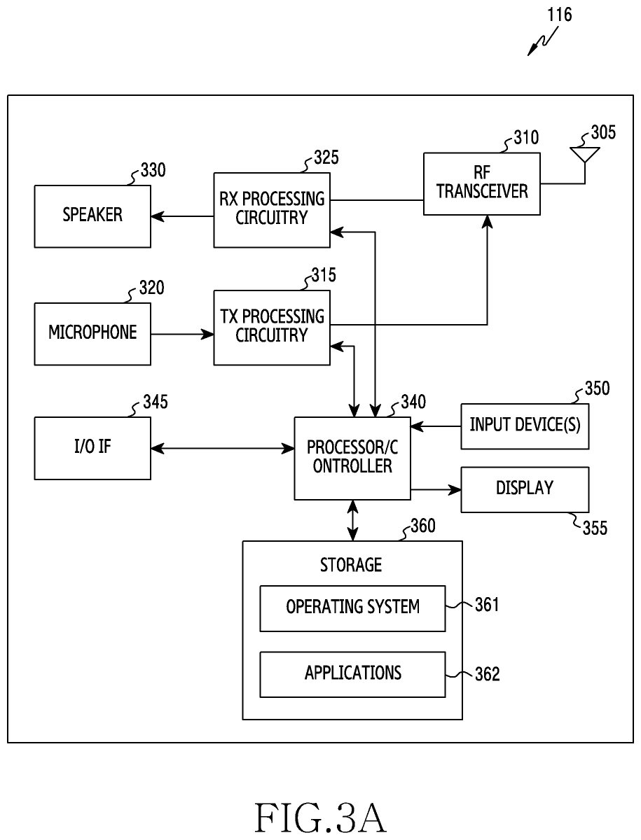

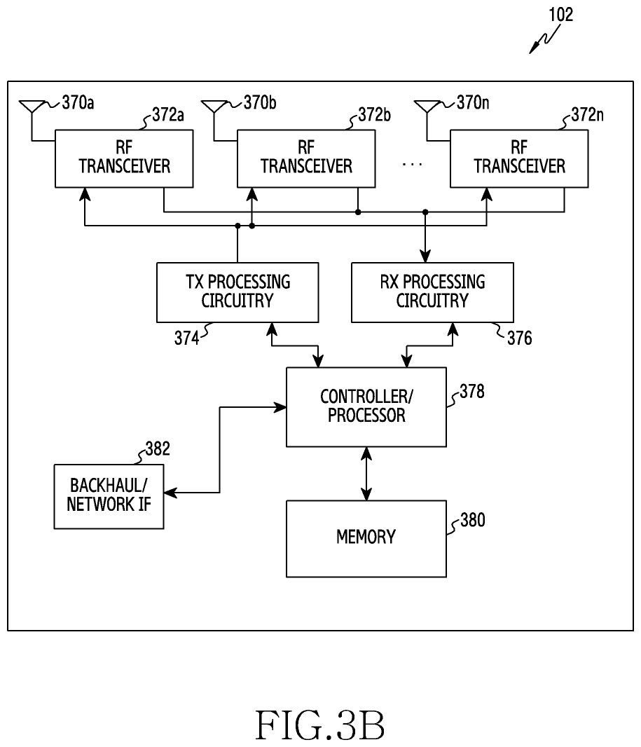

FIG. 3A illustrates a UE according to an embodiment of the disclosure.

Referring to FIG. 3A, the embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices, such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include random access memory (RAM), while another part of the memory 360 can include flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

In some implementations, two or more UEs 116 may communicate directly using one or more sidelink channels (for example, without using a base station as a medium for communication with each other). For example, the UE 116 may communicate using peer-to-peer (P2P) communication, device-to-device (D2D) communication, vehicle-to-everything (V2X) protocol (which, for example, may include vehicle-to-vehicle (V2V) protocol, vehicle-to-infrastructure (V2I) protocol, or the like), mesh network, or the like. In this case, the UE 116 may perform scheduling operations, resource selection operations, and/or other operations performed by the base station as described elsewhere herein. For example, the base station may configure the UE 116 via downlink control information (DCI), radio resource control (RRC) signaling, medium access control-control element (MAC-CE) or via system information (e.g., system information block (SIB)).

FIG. 3B illustrates a gNB according to an embodiment of the disclosure.

Referring to FIG. 3B, the embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process, such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities, such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays, a PCS (personal communications service), which may combine voice, data processing, fax and/or data communication capabilities, a personal digital assistant (PDA), which may include a radio frequency receiver, a pager, an internet/intranet access, a web browser, a notepad, a calendar and/or a global positioning system (PDA) receiver; a laptop and/or palmtop computer or other devices of the related art having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a mobile Internet device (MID) and/or a mobile phone with music/video playing functions, a smart TV, a set-top box and other devices.

With the rapid development of information industry, especially the increasing demand from mobile Internet and internet of things (IoT), it brings unprecedented challenges to the future mobile communication technology. In order to meet the unprecedented challenges, the communication industry and academia have carried out extensive research on the fifth generation (5G) mobile communication technology to face the 2020s. At present in ITU report ITU-R M.[IMT.VISION], the framework and overall goals of the future 5G has been discussed, in which the demand outlook, application scenarios and important performance indicators of 5G are described. With respect to new requirements in 5G, ITU report ITU-R M.[IMT.FUTURE TECHNOLOGY TRENDS] provides information related to the technology trends of 5G, aiming at solving significant problems, such as significantly improved system throughput, consistent user experience, scalability to support IoT, delay, energy efficiency, cost, network flexibility, support of emerging services and flexible spectrum utilization. In 3^{rd} generation partnership project), the first stage of 5G is already in progress. To support more flexible scheduling, the 3GPP decides to support variable hybrid automatic repeat request-acknowledgement (HARQ-ACK) feedback delay in 5G. In existing long term evolution (LTE) systems, a time from reception of downlink data to uplink transmission of HARQ-ACK is fixed. For example, in frequency division duplex (FDD) systems, the delay is 4 subframes. In time division duplex (TDD) systems, a HARQ-ACK feedback delay is determined for a corresponding downlink subframe based on an uplink and downlink configuration. In 5G systems, whether FDD or TDD systems, for a determined downlink time unit (for example, a downlink slot or a downlink mini slot; for another example, a PDSCH time unit), the uplink time unit (for example, a PUCCH time unit) that can feedback HARQ-ACK is variable. For example, the delay of HARQ-ACK feedback can be dynamically indicated by physical layer signaling, or different HARQ-ACK delays can be determined based on factors, such as different services or user capabilities.

The 3GPP has defined three directions of 5G application scenarios-enhanced mobile broadband (eMBB), massive machine-type communication (mMTC) and ultra-reliable and low-latency communication (URLLC). The eMBB scenario aims to further improve data transmission rate based on the existing mobile broadband service scenario, so as to enhance user experience and pursue ultimate communication experience between people. mMTC and URLLC are, for example, the application scenarios of the Internet of things, but their respective emphases are different: mMTC being mainly information interaction between people and things, while URLLC mainly reflecting communication requirements between things.

In some cases, the UE may simultaneously transmit two PUSCHs on a serving cell, and in other cases, the UE may transmit a PUSCH in a sub-band. When at least one of the two PUSCHs simultaneously transmitted overlaps with other physical channels in time domain, or when the PUSCH transmitted in the sub-band overlaps with other physical channels in time domain, how to transmit the PUSCH and/or how to solve the conflict between the PUSCH and other channels is a problem to be solved.

In order to at least solve the above technical problems, some embodiments of the disclosure provide a method performed by a terminal, the terminal (UE), a method performed by a base station and the base station in a wireless communication system, and a non-transitory computer-readable storage medium. Hereinafter, various embodiments of the disclosure will be described with reference to the accompanying drawings.

In embodiments of the disclosure, for the convenience of description, a first transceiving node and a second transceiving node are defined. For example, the first transceiving node may be a base station, and the second transceiving node may be a UE. For another example, the embodiments of the disclosure may be applicable to the scenario of sidelink communication, in which case, the first transceiver node may be a UE, and the second transceiver node may be another UE. Therefore, the first transceiving node and the second transceiving node may each be any suitable communication node. In the following description, the base station is taken as an example (but not limited thereto) to illustrate the first transceiving node, and the UE is taken as an example (but not limited thereto) to illustrate the second transceiving node.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via radio resource control (RRC) signaling, packet data convergence protocol (PDCP) signaling, or a medium access control (MAC) control element (CE).

In the following description of the disclosure, the higher layer signaling may be signaling corresponding to at least one or a combination of one or more of the following signaling.
master information block (MIB)
system information block (SIB) or SIB X (X=1,2, . . . )
RRC signaling
MAC CE
Physical layer (Layer 1 (L1)) signaling may be signaling corresponding to
at least one or a combination of one or more of the following signaling.
physical downlink control channel (PDCCH)
downlink control information (DCI)
UE-specific DCI
group common DCI
common DCI
scheduling DCI (for example, DCI for scheduling downlink or uplink data)
non-scheduling DCI (for example, DCI other than the DCI for scheduling downlink or uplink data)
physical uplink control channel (PUCCH)
uplink control information (UCI)

In embodiments of the disclosure, uplink control signaling may include

physical layer signaling and/or higher layer signaling. As described above, the physical layer signaling may include the UCI and/or PUCCH, and the higher layer signaling may include the RRC signaling and/or MAC CE.

In embodiments of the disclosure, downlink control signaling may include the physical layer signaling and/or higher layer signaling. As described above, the physical layer signaling may include one or more of the PDCCH, DCI, UE-specific DCI, group common DCI, common DCI, scheduling DCI (for example, DCI for scheduling downlink or uplink data) and non-scheduling DCI, and the higher layer signaling may include one or more of the MIB, SIB or SIB X (X=1,2, . . . ), RRC signaling or MAC CE. Therefore, “configuring or indicating X through downlink control signaling” will be understood as configuring or indicating X through physical layer signaling, or configuring or indicating X through higher layer signaling, or configuring or indicating X through a combination of higher layer signaling and physical layer signaling.

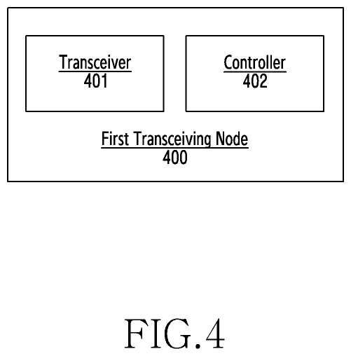

FIG. 4 illustrates a block diagram of a first transceiving node according to an embodiment of the disclosure.

Referring to FIG. 4, a first transceiving node 400 may include a transceiver 401 and a controller 402.

The transceiver 401 may be configured to transmit first data and/or first control signaling to a second transceiving node, and/or receive second data and/or second control signaling from the second transceiving node in a time unit.

The controller 402 may be an application specific integrated circuit or at least one processor. The controller 402 may be configured to control the overall operation of the first transceiving node, including controlling the transceiver 401 to transmit the first data and/or the first control signaling to the second transceiving node and receive the second data and/or the second control signaling from the second transceiving node in the time unit.

In some implementations, the controller 402 may be configured to perform one or more of operations in methods of various embodiments described below, for example, operations that can be performed by a base station.

In the following description, a base station is taken as an example (but not limited thereto) to illustrate the first transceiving node, and a UE is taken as an example (but not limited thereto) to illustrate the second transceiving node. Downlink data (but not limited thereto) is used to illustrate the first data. Downlink control signaling (but not limited thereto) is used to illustrate the first control signaling. Uplink control signaling (but not limited thereto) is used to illustrate the second control signaling.

Herein, depending on the network type, the term “base station” or “BS” can refer to any component (or a set of components) configured to provide wireless access to a network, such as a transmission point (TP), a transmission and reception point (TRP), an evolved base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio (NR) interface/access, long term evolution (LTE), LTE advanced (LTE-A), high speed packet access (HSPA), Wi-Fi 802.11a/b/g/n/ac, or the like.

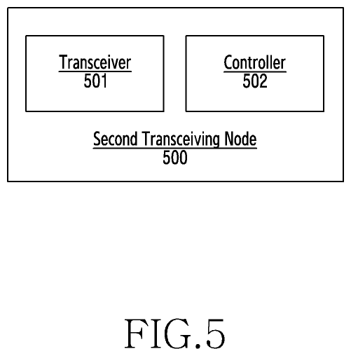

FIG. 5 illustrates a block diagram of a second transceiving node according to an embodiment of the disclosure.

Referring to FIG. 5, a second transceiving node 500 may include a transceiver 501 and a controller 502.

The transceiver 501 may be configured to receive first data and/or first control signaling from the first transceiving node, and transmit second data and/or second control signaling to the first transceiving node in a determined time unit.

The controller 502 may be an application specific integrated circuit or at least one processor. The controller 502 may be configured to control the overall operation of the second transceiving node and control the second transceiving node to implement the methods proposed in the embodiments of the disclosure. For example, the controller 502 may be configured to determine the second data and/or the second control signaling and a time unit for transmitting the second data and/or the second control signaling based on the first data and/or the first control signaling, and control the transceiver 501 to transmit the second data and/or the second control signaling to the first transceiving node in the determined time unit.

In some implementations, the controller 502 may be configured to perform one or more of operations in methods of various embodiments described below, for example, operations that can be performed by a terminal (UE).

In implementations described in connection with FIG. 4 or 5, the first data may be data transmitted by the first transceiving node to the second transceiving node. In the following examples, downlink data carried by a physical downlink shared channel (PDSCH) is taken as an example (but not limited thereto) to illustrate the first data.

In implementations described in connection with FIG. 4 or 5, the second data may be data transmitted by the second transceiving node to the first transceiving node. In the following examples, uplink data carried by a physical uplink shared channel (PUSCH) is taken as an example to illustrate the second data, but not limited thereto.

In implementations described in connection with FIG. 4 or 5, the second control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a physical downlink control channel (PDCCH) and/or control signaling carried by a physical downlink shared channel (PDSCH). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In implementations described in connection with FIG. 4 or 5, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a physical uplink control channel (PUCCH) and/or control signaling carried by a physical uplink shared channel (PUSCH). A type of UCI may include one or more of: HARQ-ACK information, scheduling request (SR), link recovery request (LRR), channel state information (CSI) or configured grant (CG) UCI. In embodiments of the disclosure, when UCI is carried by a PUCCH, the UCI may be used interchangeably with the PUCCH.

In some implementations, a PUCCH with an SR may be a PUCCH with a positive SR and/or a negative SR. The SR may be the positive SR and/or the negative SR

In some implementations, the CSI may also be Part 1 CSI and/or Part 2 CSI.

In implementations described in connection with FIG. 4 or 5, a first time unit is a time unit in which the first transceiving node transmits the first data and/or the first control signaling. In some examples, a downlink time unit or downlink slot may be taken as an example (but not limited thereto) to illustrate the first time unit.

In implementations described in connection with FIG. 4 or 5, a second time unit is a time unit in which the second transceiving node transmits the second data and/or the second control signaling. In the following examples, an uplink time unit or uplink slot or PUCCH slot or primary cell (PCell) slot or PUCCH slot on PCell is taken as an example (but not limited thereto) to illustrate the second time unit. The “PUCCH slot” may be understood as a PUCCH transmission slot.

In embodiments of the disclosure, a time unit (for example, the first time unit or the second time unit) may be one or more slots, one or more subslots, one or more OFDM symbols, one or more spans, or one or more subframes.

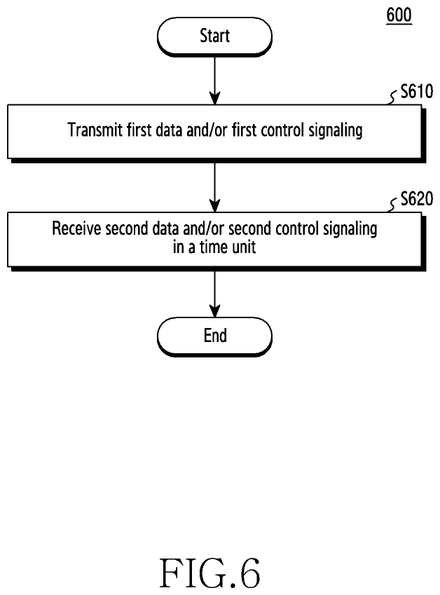

FIG. 6 illustrates a flowchart of a method 600 performed by a base station according to an embodiment of the disclosure.

Referring to FIG. 6, in operation S610, the base station transmits downlink data and/or downlink control information.

In operation S620, the base station receives uplink data and/or uplink control information from a UE in a time unit.

In some implementations, operations S610 and/or S620 may be performed based on the methods described according to various embodiments of the disclosure (e.g., various methods described below).

In some implementations, the method 600 may omit one or more of operation S610 or S620, or may include additional operations, for example, the operations performed by the base station based on the methods described according to various embodiments of the disclosure (e.g., various methods described below).

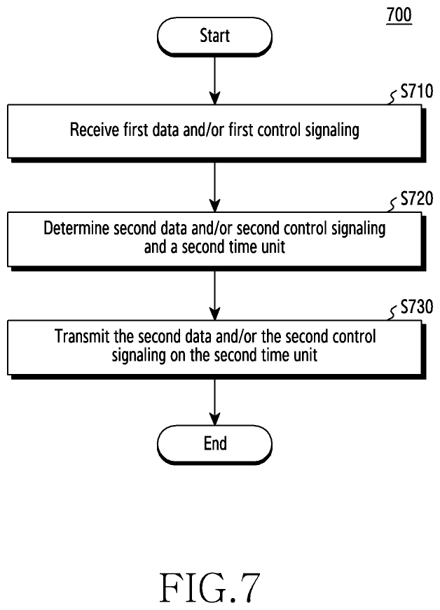

FIG. 7 illustrates a flowchart of a method 700 performed by a UE according to an embodiment of the disclosure.

Referring to FIG. 7, in operation S710, the UE may receive downlink data (e.g., downlink data carried by a PDSCH) and/or downlink control signaling from a base station. For example, the UE may receive the downlink data and/or the downlink control signaling from the base station based on predefined rules and/or received configuration parameters.

In operation S720, the UE determines uplink data and/or uplink control signaling and a second time unit based on the downlink data and/or downlink control signaling.

In operation S730, the UE transmits the uplink data and/or the uplink control signaling to the base station on the second time unit.

In some implementations, operations S710 and/or S720 and/or S730 may be performed based on the methods described according to various embodiments of the disclosure (e.g., various methods described below).

In some implementations, the method 700 may omit one or more of operation S710, S720 or S730, or may include additional operations, for example, the operations performed by the UE (terminal) based on the methods described according to various embodiments of the disclosure (e.g., various methods described below).

In some implementations, acknowledgement/negative acknowledgement (ACK/NACK) for downlink transmissions may be performed through HARQ-ACK.

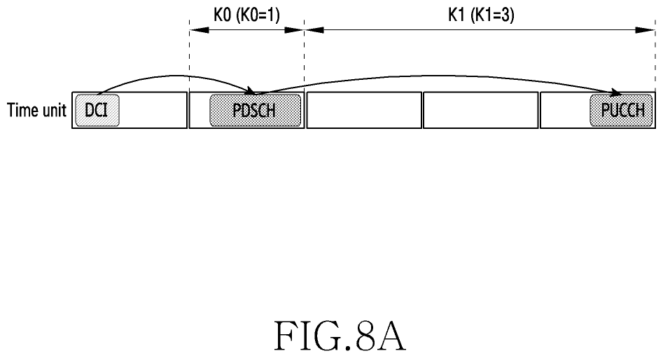

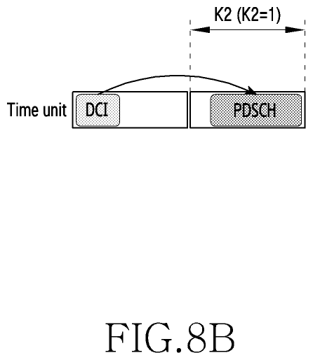

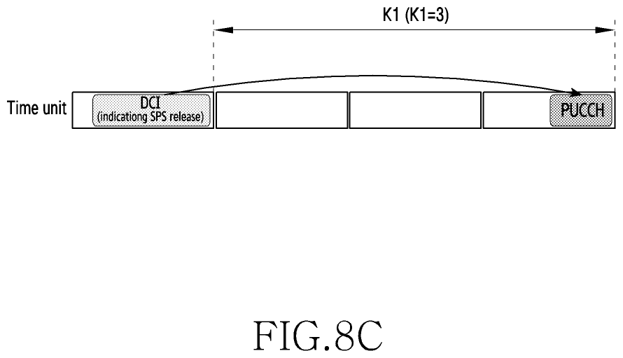

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 8A, 8B, and 8C.

FIGS. 8A, 8B, and 8C illustrate uplink transmission timing according to various embodiments of the disclosure.

Referring to 8A, 8B, and 8C, in an example, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 8A gives an example in which K0=1. In the example illustrated in FIG. 8A, the time interval from the PDSCH scheduled by the DCI to the PDCCH carrying the DCI is one slot. In embodiments of the disclosure, “a UE receives DCI” may mean that “the UE detects the DCI”.

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 8B gives an example in which K2=1. In the example illustrated in FIG. 8B, the time interval between the PUSCH scheduled by the DCI and the PDCCH carrying the DCI is one slot. K2 may also represent a time interval between a PDCCH for activating a CG (configured grant) PUSCH and the first activated CG PUSCH. In examples of the disclosure, unless otherwise specified, the PUSCH may be a dynamically scheduled PUSCH (e.g., scheduled by DCI) (e.g., may be referred to as DG (dynamic grant) PUSCH, in embodiments of the disclosure) and/or a PUSCH not scheduled by DCI (e.g., CG PUSCH).

In yet another example, the UE receives the PDSCH, and may transmit HARQ-ACK information for the PDSCH reception in a PUCCH in the second time unit. For example, a timing parameter (which may also be referred to as a timing value) K1 (e.g., the higher layer parameter dl-DataToUL-ACK) may be used to represent a time interval between the PUCCH for transmitting the HARQ-ACK information for the PDSCH reception and the PDSCH, and K1 may be in units of second time units, such as slots or subslots. In a case where K1 is in units of slots, the time interval is a value of a slot offset between the PUCCH for feeding back the HARQ-ACK information for the PDSCH reception and the PDSCH, and K1 may be referred to as a slot timing value. For example, FIG. 8A gives an example in which K1=3. In the example illustrated in FIG. 8A, the time interval between the PUCCH for transmitting the HARQ-ACK information for the PDSCH reception and the PDSCH is 3 slots. It should be noted that in embodiments of the disclosure, the timing parameter K1 may be used interchangeably with a timing parameter K₁, the timing parameter K0 may be used interchangeably with a timing parameter K₀, and the timing parameter K2 may be used interchangeably with a timing parameter K₂.

The PDSCH may be a PDSCH scheduled by the DCI and/or a SPS PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by DCI) and/or HARQ-ACK indicated by a DCI format (e.g., HARQ-ACK for a PDSCH reception scheduled by a DCI format).

In yet another example, the UE receives the DCI (e.g., DCI indicating SPS (Semi-Persistent Scheduling) PDSCH release (deactivation)), and may transmit HARQ-ACK information for the DCI in the PUCCH in the second time unit. For example, the timing parameter K1 may be used to represent a time interval between the PUCCH for transmitting the HARQ-ACK information for the DCI and the DCI, and K1 may be in units of second time units, such as slots or subslots. For example, FIG. 8C gives an example in which K1=3. In the example of FIG. 8C, the time interval between the PUCCH for transmitting the HARQ-ACK information for the DCI and the DCI is 3 slots. For example, the timing parameter K1 may be used to represent a time interval between a PDCCH reception carrying DCI indicating SPS PDSCH release (deactivation) and the PUCCH feeding back HARQ-ACK for the PDCCH reception.

In some implementations, in operation S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (e.g., in operation S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or a MAC CE.

In some implementations, downlink channels (downlink resources) may include PDCCHs and/or PDSCHs. Uplink channels (uplink resources) may include PUCCHs and/or PUSCHs.

In some implementations, the UE may be configured with two levels of priorities for uplink transmission (for example, the UE is configured with the higher layer parameter PUCCH-ConfigurationList). For example, the UE may be configured to multiplex UCIs with different priorities by higher layer signaling (e.g., by the higher layer parameter uci-MuxWithDiffPrio), otherwise (e.g., if the UE is not configured to multiplex UCIs with different priorities), the UE performs prioritization for PUCCHs and/or PUSCHs with different priorities. For example, the two levels of priorities may include a first priority and a second priority which are different from each other. In an example, the first priority may be higher than the second priority, that is, the first priority is the higher priority, and the second priority is the lower priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority. In some embodiments of the disclosure, the terms “first priority”, “higher priority”, “greater priority index” and “priority index 1” may be used interchangeably. In embodiments of the disclosure, the terms “second priority”, “lower priority”, “smaller priority index” and “priority index 0” may be used interchangeably.

For example, multiplexing of multiple PUCCHs and/or PUSCHs overlapping in time domain may include multiplexing of UCI information of the PUCCH in a PUCCH or PUSCH.

For example, prioritizing of two PUCCHs and/or PUSCHs overlapping in time domain by the UE may include that the UE transmits the PUCCH or the PUSCH with the higher priority and/or the UE does not transmit the PUCCH or the PUSCH with the lower priority.

In some implementations, the UE may be configured with a subslot-based PUCCH transmission. For example, a subslot length parameter (which may also be referred to as a parameter with respect to a subslot length in embodiments of the disclosure) (e.g., the higher layer parameter subslotLengthForPUCCH) of each PUCCH configuration parameter of the first PUCCH configuration parameter and the second PUCCH configuration parameter may be 7 OFDM symbols or 6 OFDM symbols or 2 OFDM symbols. Subslot configuration length parameters in different PUCCH configuration parameters may be configured separately. If no subslot length parameter is configured in a PUCCH configuration parameter, the scheduling time unit of this PUCCH configuration parameter is one slot by default. If a subslot length parameter is configured in the PUCCH configuration parameter, the scheduling time unit of this PUCCH configuration parameter is L (L is the configured subslot configuration length) OFDM symbols.

The mechanism of slot-based PUCCH transmissions is basically the same as that of subslot-based PUCCH transmissions. In the disclosure, a slot may be used to represent a PUCCH occasion unit; for example, if the UE is configured with subslots, a slot which is a PUCCH occasion unit may be replaced with a subslot. For example, it may be specified by protocols that if the UE is configured with the subslot length parameter (e.g., the higher layer parameter subslotLengthForPUCCH), unless otherwise indicated, a number of symbols contained in the slot of the PUCCH transmission is indicated by the subslot length parameter.

For example, if the UE is configured with the subslot length parameter, and subslot n is the last uplink subslot overlapping with a PDSCH reception or PDCCH reception (e.g., SPS PDSCH release, and/or indicating SCell dormancy, and/or triggering a Type-3 HARQ-ACK codebook report and without scheduling a PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, if the UE is not configured with the subslot length parameter, and slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

In embodiments of the disclosure, unicast may refer to a manner in which a network communicates with a UE, and multicast (or groupcast) may refer to a manner in which a network communicates with multiple UEs. For example, a unicast PDSCH may be a PDSCH received by one UE, and the scrambling of the PDSCH may be based on a radio network temporary identifier (RNTI) specific to the UE, e.g., cell-RNTI (C-RNTI). A multicast PDSCH may be a PDSCH received by more than one UE simultaneously, and the scrambling of the multicast PDSCH may be based on a UE-group common RNTI. For example, the UE-group common RNTI for scrambling the multicast PDSCH may include an RNTI (which may be referred to as Group RNTI (G-RNTI) in embodiments of the disclosure) for scrambling of a dynamically scheduled multicast transmission (e.g., PDSCH) or an RNTI (which may be referred to as group configured scheduling RNTI (G-CS-RNTI) in embodiments of the disclosure) for scrambling of a multicast SPS transmission (e.g., SPS PDSCH). UCI(s) of the unicast PDSCH may include HARQ-ACK information, SR, or CSI of the unicast PDSCH reception. UCI(s) of the multicast PDSCH may include HARQ-ACK information for the multicast PDSCH reception. In embodiments of the disclosure, “multicast” may also be replaced by “broadcast”.

In some implementations, a HARQ-ACK codebook may include HARQ-ACK information for one or more PDSCHs and/or DCI. If the HARQ-ACK information for the one or more PDSCHs and/or DCI is transmitted in a same second time unit, the UE may generate the HARQ-ACK codebook based on a predefined rule. For example, if a PDSCH is successfully decoded, the HARQ-ACK information for the PDSCH reception is positive ACK. The positive ACK may be represented by 1 in the HARQ-ACK codebook, for example. If a PDSCH is not successfully decoded, the HARQ-ACK information for the PDSCH reception is Negative ACK (NACK). NACK may be represented by 0 in the HARQ-ACK codebook, for example. For example, the UE may generate the HARQ-ACK codebook based on the pseudo code specified by protocols. In an example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits the HARQ-ACK information (ACK) for the DCI format. In yet another example, if the UE receives a DCI format that indicates to transmit HARQ-ACK information (e.g., a Type-3 HARQ-ACK codebook) of all HARQ-ACK processes of all configured serving cells, the UE transmits the HARQ-ACK information of all HARQ-ACK processes of all configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, if the UE receives a DCI format that schedules a PDSCH, the UE transmits HARQ-ACK information for the PDSCH reception. In yet another example, the UE receives a SPS PDSCH, and the UE transmits HARQ-ACK information for the SPS PDSCH reception. In yet another example, if the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of the SPS PDSCH reception, the UE does not receive the SPS PDSCH. In yet another example, if the UE is configured by higher layer signaling to receive a SPS PDSCH according to a predefined rule, the UE transmits HARQ-ACK information for the SPS PDSCH reception. It should be noted that, in embodiments of the disclosure, “‘A’ overlaps with ‘B’” may mean that ‘A’ at least partially overlaps with ‘B’. For example, “‘A’ overlaps with ‘B’” includes a case where ‘A’ completely overlaps with ‘B’. “‘A’ overlaps with ‘B’” may mean that ‘A’ overlaps with ‘B’ in time domain and/or ‘A’ overlaps with ‘B’ in frequency domain.

In some implementations, if HARQ-ACK information transmitted in a same second time unit does not include HARQ-ACK information for any DCI format, nor does it include HARQ-ACK information for a dynamically scheduled PDSCH (e.g., a PDSCH scheduled by a DCI format) and/or DCI, or the HARQ-ACK information transmitted in the same second time unit only includes HARQ-ACK information for one or more SPS PDSCH receptions, the UE may generate HARQ-ACK information (e.g., HARQ-ACK information only for SPS PDSCH receptions) according to a rule for generating a HARQ-ACK codebook for SPS PDSCHs. The UE may multiplex the HARQ-ACK information only for SPS PDSCH receptions in a specific PUCCH resource. For example, if the UE is configured with a PUCCH list parameter for SPS (e.g., SPS-PUCCH-AN-List), the UE multiplexes the HARQ-ACK information only for SPS PDSCH receptions in a PUCCH of a PUCCH list for SPS. For example, the UE determines a PUCCH resource in the PUCCH list for the SPS according to a number of HARQ-ACK information bits. If the UE is not configured with the PUCCH list parameter for SPS, the UE multiplexes the HARQ-ACK information only for SPS PDSCH receptions in a PUCCH resource specific to SPS HARQ-ACK (for example, the PUCCH resource is configured by the parameter n1PUCCH-AN).

In some implementations, if the HARQ-ACK information transmitted in the same second time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook) or a dynamic HARQ-ACK codebook (e.g., Type-2 HARQ-ACK codebook in 3GPP) according to a PDSCH HARQ-ACK codebook configuration parameter (e.g., the higher layer parameter pdsch-HARQ-ACK-Codebook). The dynamic HARQ-ACK codebook may also be an enhanced dynamic HARQ-ACK codebook (e.g., Type-2 HARQ-ACK codebook based on grouping and HARQ-ACK retransmission). The UE may multiplex the HARQ-ACK information in a PUCCH resource for HARQ-ACK associated with dynamically scheduling, which may be configured in a resource set et list parameter (e.g., the parameter resourceSetToAddModList). The UE determines a PUCCH resource set (e.g., the parameter PUCCH-ResourceSet) in a resource set list according to a number of HARQ-ACK information bits, and the PUCCH resource may be determined as a PUCCH in the PUCCH resource set according to a PRI (PUCCH Resource Indicator) field indication in the last DCI format.

In some implementations, if the HARQ-ACK information transmitted in the same second time unit includes only HARQ-ACK information for SPS PDSCHs (e.g., a PDSCH not scheduled by a DCI format), the UE may generate the HARQ-ACK codebook according to a rule for generating a HARQ-ACK codebook for SPS PDSCH receptions (e.g., the pseudo code of a HARQ-ACK codebook for SPS PDSCH receptions).

The semi-static HARQ-ACK codebook (e.g., Type-1 HARQ-ACK codebook), may determine the size of the HARQ-ACK codebook and an order of HARQ-ACK bits according to a semi-statically configured parameter (e.g., a parameter configured by higher layer signaling). For a serving cell c, an active downlink BWP (bandwidth part) and an active uplink BWP, the UE determines a set of M_{A,c} occasions for candidate PDSCH receptions for which the UE can transmit corresponding HARQ-ACK information in a PUCCH in an uplink slot n_{U}.

M_{A,c} may be determined by at least one of:
a) HARQ-ACK slot timing values K1 of the active uplink BWP;
b) a downlink time domain resource allocation (TDRA) table;
c) an uplink SCS configuration and a downlink SCS configuration;
d) a semi-static uplink and downlink frame structure configuration;
e) a downlink slot offset parameter (e.g., the higher layer parameter N_{slot,offset,c}^{DL}) for the serving cell c and its corresponding slot offset SCS (e.g., the higher layer parameter μ_{offset,DL,c}), and a slot offset parameter (e.g., the higher layer parameter N_{slot,offset}^{UL}) for a primary serving cell and its corresponding slot offset SCS (e.g., the higher layer parameter μ_{offset,UL}).

The parameter K1 is used to determine a candidate uplink slot, and then determine candidate downlink slots according to the candidate uplink slot. The candidate downlink slots satisfy at least one of the following conditions: (i) if the time unit of the PUCCH is a subslot, the end of at least one candidate PDSCH reception in the candidate downlink slots overlaps with the candidate uplink slot in time domain; or (ii) if the time unit of the PUCCH is a slot, the end of the candidate downlink slots overlap with the candidate uplink slot in time domain. It should be noted that, in embodiments of the disclosure, a starting symbol may be used interchangeably with a starting position, and an end symbol may be used interchangeably with an end position. In some implementations, the starting symbol may be replaced by the end symbol, and/or the end symbol may be replaced by the starting symbol.

A number of PDSCHs in a candidate downlink slot for which HARQ-ACK needs to be fed back is determined by a maximum value of a number of non-overlapping valid PDSCHs in the downlink slot (e.g., the valid PDSCHs may be PDSCHs that do not overlap with semi-statically configured uplink symbols). Time domain resources occupied by the PDSCHs may be determined by (i) a time domain resource allocation table configured by higher layer signaling (in embodiments of the disclosure, it may also be referred to as a table associated with time domain resource allocation) and (ii) a certain row in the time domain resource allocation table dynamically indicated by a DCI. Each row in the time domain resource allocation table may define information with respect to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a starting symbol and allocation length. For example, for the first row of the time domain resource allocation table, a start OFDM symbol is 0 and an OFDM symbol length is 4; for the second row of the time domain resource allocation table, the start OFDM symbol is 4 and the OFDM symbol length is 4, and for the third row of the time domain resource allocation table, the start OFDM symbol is 7 and the OFDM symbol length is 4. The DCI for scheduling the PDSCH may indicate any row in time domain resource allocation table. When all OFDM symbols in the downlink slot are downlink symbols, the maximum value of the number of non-overlapping valid PDSCHs in the downlink slot is 2. At this time, the Type-1 HARQ-ACK codebook may need to feed back HARQ-ACK information for two PDSCHs in the downlink slot on the serving cell.

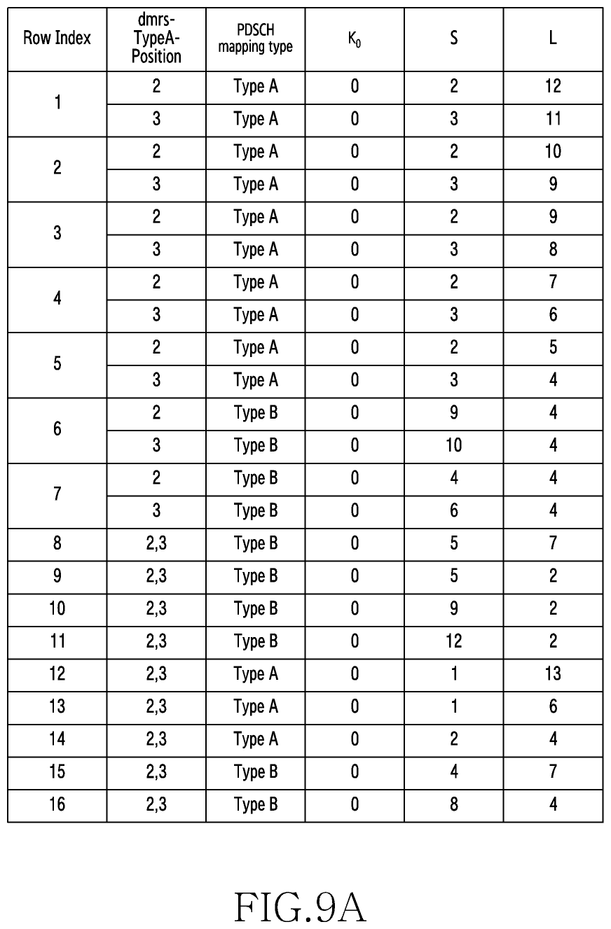

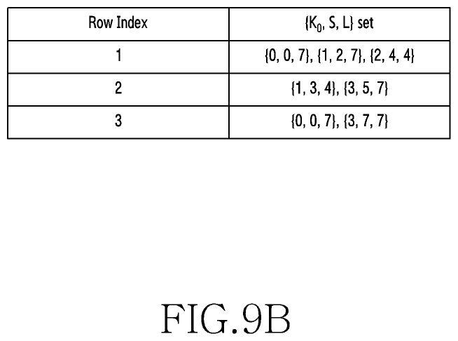

FIGS. 9A and 9B illustrate time domain resource allocation tables according to various embodiments of the disclosure.

Referring to FIG. 9A, it illustrates a time domain resource allocation table in which one PDSCH is scheduled in one row, and FIG. 9B illustrates a time domain resource allocation table in which multiple PDSCHs are scheduled in one row. Referring to FIG. 9A, each row corresponds to a set of {K0, mapping type, SLIV}, which includes a timing parameter K0 value, a mapping type, and an SLIV.

Referring to FIG. 9B, unlike FIG. 9A, each row corresponds to multiple sets of {K0, mapping type, SLIV}.

In some implementations, the dynamic HARQ-ACK codebook (e.g., Type-2 HARQ-ACK codebook) and/or the enhanced dynamic HARQ-ACK codebook (e.g., Type-2 HARQ-ACK based on grouping and HARQ-ACK retransmission) may determine a size and an order of the HARQ-ACK codebook according to an assignment indicator. For example, the assignment indicator may be a DAI (Downlink Assignment Indicator). In the following embodiments, the assignment indicator as the DAI is taken as an example for illustration. However, the embodiments of the disclosure are not limited thereto, and any other suitable assignment indicator may be adopted.

In some implementations, a DAI field includes at least one of a first DAI and a second DAI.

In some examples, the first DAI may be a counter-DAI (C-DAI). The first DAI may indicate an accumulative number of at least one of DCI scheduling PDSCH(s), DCI indicating SPS PDSCH release (deactivation), or DCI indicating secondary cell dormancy. For example, the accumulative number may be an accumulative number up to the current serving cell and/or the current time unit. For example, C-DAI may refer to an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)), or an accumulative number of PDCCH(s) up to the current time unit, or an accumulative number of PDSCH transmission(s) up to the current time unit, or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit, or an accumulative number of PDSCHs (the PDSCHs are PDSCHs with corresponding PDCCHs) already scheduled by the base station up to the current serving cell and/or the current time unit, or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI(s) indicating SPS PDSCH release (deactivation), or DCI(s) indicating secondary cell dormancy may be determined by the time when the first DAI is received and the information of the first DAI. The first DAI may be included in a downlink DCI format.

In some examples, the second DAI may be a total-DAI (T-DAI). The second DAI may indicate a total number of at least one of all PDSCH receptions, DCI indicating SPS PDSCH release (deactivation), or DCI indicating secondary cell dormancy. For example, the total number may be a total number of all serving cells up to the current time unit. For example, T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (e.g., the PDSCHs are PDSCHs with corresponding PDCCHs) already scheduled by the base station up to the current serving cell and/or the current time unit. The second DAI may be included in the downlink DCI format and/or an uplink DCI format. The second DAI included in the uplink DCI format is also referred to as UL DAI.

In the following examples, the first DAI as the C-DAI and the second DAI as the T-DAI are taken as an example for illustration, but the examples are not limited thereto.

Tables 1 and 2 show a correspondence between the DAI field and V_{T-DAI,m} or V_{C-DAI,c,m} or V_{T-DAI}^{UL}. Numbers of bits of the C-DAI and T-DAI are limited.

For example, in case that the C-DAI or T-DAI is represented with 2 bits, the value of the C-DAI or T-DAI in the DCI may be determined by equations in Table 1. V_{T-DAI,m} or V_{T-DAI}^{UL} is the value of the T-DAI in DCI received in a PDCCH Monitoring Occasion (MO) m, and V_{C-DAI,c,m} is the value of the C-DAI in DCI for a serving cell c received in the PDCCH monitoring occasion m. Both V_{T-DAI,m} and V_{C-DAI,c,m} are related to a number of bits of the DAI field in the DCI. MSB is the Most Significant Bit and LSB is the Least Significant Bit.

TABLE 1

| | V_{T-DAI,m} or | |
|---|---|---|
| MSB, LSB of | V_{C-DAI,c,m} or | |
| DAI Field | V_{T-DAI}^{UL} | Y |
| 0, 0 | 1 | (Y − 1) mod 4 + 1 = 1 |
| 0, 1 | 2 | (Y − 1) mod 4 + 1 = 2 |
| 1, 0 | 3 | (Y − 1) mod 4 + 1 = 3 |
| 1, 1 | 4 | (Y − 1) mod 4 + 1 = 4 |

For example, when the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the base station (the value of the DAI before conversion by the equation in the table).

For example, in case that the C-DAI or T-DAI in the DCI is 1 bit, values greater than 2 may be represented by equations in Table 2.

TABLE 2

| | V_{T-DAI,m} or | |
|---|---|---|
| DAI field | V_{C-DAI,c,m} | Y |
| 0 | 1 | (Y − 1) mod 2 + 1 = 1 |
| 1 | 2 | (Y − 1) mod 2 + 1 = 2 |

In some implementations, whether to feed back HARQ-ACK information may be configured by higher layer parameters or dynamically indicated by DCI. The mode of feeding back (or reporting) the HARQ-ACK information (HARQ-ACK feedback mode or HARQ-ACK reporting mode) may also be at least one of the following modes.

HARQ-ACK feedback mode 1: transmitting ACK or NACK (ACK/NACK). For example, for a PDSCH reception, if the UE decodes a corresponding transport block (TB) correctly, the UE transmits ACK; and/or, if the UE does not decode the corresponding transport block correctly, the UE transmits NACK. For example, a HARQ-ACK information bit of the HARQ-ACK information provided according to the HARQ-ACK feedback mode 1 is an ACK value or a NACK value.

HARQ-ACK feedback mode 2: transmitting NACK only (NACK-only). For example, for a PDSCH reception, if the UE decodes the corresponding transport block correctly, the UE does not transmit the HARQ-ACK information; and/or, if the UE does not decode the corresponding transport block correctly, the UE transmits NACK. For example, at least one HARQ-ACK information bit of the HARQ-ACK information provided according to the HARQ-ACK feedback mode 2 is a NACK value. For example, for the HARQ-ACK feedback mode 2, the UE does not transmit a PUCCH that would include only HARQ-ACK information with ACK values.

In some implementations, a PUSCH conflicting with other physical channel(s) may be at least one of:

The PUSCH overlapping in time domain with other PUSCH(s) and/or PUCCH(s) and/or PDSCH(s) and/or PDCCH(s) on a same serving cell.

The PUSCH overlapping in time domain with a PUCCH. For example, the PUSCH overlaps with a PUCCH in a different serving cell in time domain, and/or the serving cell does not support simultaneous transmission of the PUSCH and PUCCH.

In some implementations, a PDSCH conflicting with other physical channel(s) may be at least one of:

The PDSCH overlapping in time domain with other PUSCH(s) and/or PUCCH(s) and/or PDSCH(s) on a same serving cell.

The PDSCH overlapping in both time domain and frequency domain with a PDCCH on a same serving cell.

In some implementations, a PUCCH conflicting with other physical channel(s) may be at least one of:

The PUCCH overlapping in time domain with other PUCCH(s) and/or PUSCH(s).

The PUCCH overlapping in time domain with other PDSCH(s) on a same serving cell.

In some implementations, a PDCCH conflicting with other physical channel(s) may be at least one of:

The PDCCH overlapping in time domain with other PUSCH(s) and/or PUCCH(s) on a same serving cell.

The PDCCH overlapping both time domain and frequency domain with other PDSCH(s) on a same serving cell.

In some implementations, “a set of overlapping channels” may be understood as that each channel of the set of overlapping channels overlaps (or conflicts) with at least one of channels in the set except this channel. The channels may include one or more PUCCHs and/or one or more PUSCHs. For example, “a set of overlapping channels” may include “a set of overlapping PUCCHs and/or PUSCHs”. As a specific example, when a first PUCCH overlaps with at least one of a second PUCCH and a third PUCCH, the second PUCCH overlaps with at least one of the first PUCCH and the third PUCCH, and the third PUCCH overlaps with at least one of the first PUCCH and the second PUCCH, the first PUCCH, the second PUCCH and the third PUCCH constitute a set of overlapping channels (PUCCHs). For example, the first PUCCH overlaps with the second PUCCH and the third PUCCH, and the second PUCCH and the third PUCCH do not overlap.

It should be noted that, in embodiments of the disclosure, “resolving overlapping channels” may be understood as resolving the conflict of overlapping channels. For example, when a PUCCH overlaps with a PUSCH, resolving the overlapping or conflict may include multiplexing UCI of the PUCCH in the PUSCH, or may include transmitting the PUCCH or PUSCH with a higher priority. For another example, when a PUCCH overlaps with one or another PUCCH, resolving the overlapping or conflict may include multiplexing UCI in a PUCCH, or may include transmitting the PUCCH with a higher priority. For yet another example, when two PUSCHs on a same serving cell overlap, resolving the overlapping or conflict may include transmitting a PUSCH with a higher priority of the two PUSCHs.

It should be noted that, unless the context clearly indicates otherwise, all or one or more of the methods, steps or operations described in embodiments of the disclosure may be specified by protocols and/or configured by higher layer signaling and/or indicated by dynamic signaling. The dynamic signaling may be PDCCH and/or DCI and/or DCI format. For example, SPS PDSCH and/or CG PUSCH may be dynamically indicated in corresponding activated DCI/DCI format/PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B). Unless otherwise specified, the parameters in the embodiments of the disclosure may be higher layer parameters. For example, the higher layer parameters may be parameters configured or indicated by higher layer signaling (e.g., RRC signaling).

It should be noted that, a primary cell (PCell) or primary secondary cell (PSCell) in embodiments of the disclosure may be used interchangeably with a cell having a PUCCH. A serving cell may be used interchangeably with a cell.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling of multiple PDSCH/PUSCHs in embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured and/or indicated with a transmission with repetitions” may be understood that the number of the repetitions of the transmission is greater than 1. For example, “PUCCH configured and/or indicated with repetitions” may be replaced with “PUCCH repeatedly transmitted on more than one slot/sub-slot”. “Not configured and/or indicated with a transmission with repetitions” may be understood that the number of the repetitions of the transmission equals to 1. For example, “PUCCH that is not configured and/or indicated with repetitions” may be replaced by “PUCCH transmission with the number of the repetitions of 1”. For example, the UE may be configured with a parameter N_{PUCCH}^{repeat} related to the number of repetitions of PUCCH; When the parameter N_{PUCCH}^{repeat} is greater than 1, it may mean that the UE is configured with a PUCCH transmission with repetitions, and the UE may repeat the PUCCH transmission on N_{PUCCH}^{repeat} time units (e.g., slots); when the parameter is equal to 1, it may mean that the UE is not configured with a PUCCH transmission with repetitions. For example, the repeatedly transmitted PUCCH may include only one type of UCI. If the PUCCH is configured with repetitions, in embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/PUSCHs on a same serving cell and/or multiple PDSCHs/PUSCHs on different serving cells.

It should be noted that, the multiple manners described in the disclosure may be combined in any order. In a combination, a manner may be performed one or more times.

It should be noted that, steps of methods of the disclosure may be implemented in any order.

It should be noted that, in embodiments of the disclosure, “canceling a transmission” may mean canceling the transmission of the entire uplink channel and/or cancelling the transmission of a part of the uplink channel.

It should be noted that, in embodiments of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in embodiments of the disclosure, a PUCCH/PUSCH carrying A may be understood as a PUCCH/PUSCH only carrying/with A, and may also be understood as a PUCCH/PUSCH carrying/with at least A.

It should be noted that, in embodiments of the disclosure, “slot” may be replaced by “subslot” or “time unit”.

It should be noted that, in embodiments of the disclosure, “performing a predefined methods (or step) if a predefined condition is satisfied” and “not performing the predefined methods (or step) if the predefined conditions is not satisfied” may be used interchangeably. “Not performing a predefined method (or step) if a predefined condition is satisfied” and “performing the predefined methods (or step) if the predefined condition is not satisfied” may be used interchangeably. In embodiments of the disclosure, the term “predefined condition” may be used interchangeably with “specified condition”, “predetermined condition” or “condition”.

If the UE would transmit multiple overlapping PUCCHs in a slot or multiple overlapping PUCCHs and PUSCHs in a slot, and the UE is configured to multiplex different UCI types in one PUCCH, and at least one of the multiple overlapping PUCCHs or the PUSCHs is in response to a DCI format detection by the UE, if the following conditions (in embodiments of the disclosure, such conditions may be called conditions for UCI multiplexing, or simply UCI multiplexing conditions) are satisfied, the UE multiplexes all corresponding UCI types. If one of the PUCCH transmissions or PUSCH transmissions is in response to a DCI format detection by the UE, the UE expects that the first symbol S₀ of the earliest PUCCH or PUSCH, among a group of overlapping PUCCHs and PUSCHs in a slot, satisfies the following timeline conditions (in embodiments of the disclosure, such timeline conditions may be called conditions for UCI multiplexing, or simply UCI multiplexing conditions)

If there is no aperiodic CSI report multiplexed in a PUSCH in the group of overlapping PUCCHs and PUSCHs (or if at least one PUSCH is included in the group of overlapping PUCCHs and PUSCHs), S₀ is not before a symbol (with CP) starting after T_{proc,2}^{mux} time after the last symbol of

any PDCCH with a DCI format scheduling an overlapping PUSCH, and

any PDCCH providing a DCI format with corresponding HARQ-ACK information in an overlapping PUCCH in the slot.

If there is at least one PUSCH in the group of overlapping PUCCHs and PUSCHs, T_{proc,2}^{mux} is given by maximum of {T_{proc,2}^{mux,1}, . . . , T_{proc,2}^{mux,i}, . . . }, where for the i-th PUSCH which is in the group of overlapping PUCCHs and PUSCHs, T_{proc,2}^{mux,i}=max((N₂+d_{2,1}+1)·(2048+144)·κ·2^{-μ}·T_{C}+T_{switch}, d_{2,2}), or T_{proc,2}^{mux,i}=max((N₂+d_{2,1}+1)·(2048+144)·κ·2^{-μ}·T_{C}+T_{switch}, d_{2,2}), or T_{proc,2}^{mux,i}=max((N₂+d_{2,1}+1)·(2048+144)·κ·2^{-μ}·T_{C}+T_{switch}, d_{2,2}), where d_{2,1}, d_{2,2} and T_{switch} correspond to the i-th PUSCH, d_{2,1} is a parameter related to DM-RS. For example, if the first symbol of the PUSCH allocation consists of DM-RS only, then d_{2,1}=0, otherwise d_{2,1}=1. d_{2,2} is a BWP switching time. N₂ is selected based on the UE PUSCH processing capability (e.g., PUSCH timing capability) and SCS configuration μ of the i-^{th} PUSCH, where μ corresponds to the smallest SCS configuration among SCS configurations used for the PDCCH scheduling the i-^{th} PUSCH, the PDCCHs scheduling the PDSCHs, or providing the DCI format without scheduling PDSCHs, with corresponding HARQ-ACK information on a PUCCH which is in the group of overlapping PUCCHs/PUSCHs, and all PUSCHs in the group of overlapping PUCCH and PUSCH.

The conditions (e.g., timeline conditions) for UCI multiplexing described above are only examples, and embodiments of the disclosure are not limited thereto. Any suitable conditions for UCI multiplexing may be set.

In some implementations, when the UE transmits multiple PUSCHs (e.g., multiple PUSCHs on corresponding multiple serving cells) in a slot (e.g., with reference slots for PUCCH transmissions) and the multiple PUSCHs overlap with a PUCCH carrying UCI in the slot, the UE selects all the PUSCHs overlapping with the PUCCH as the candidate PUSCHs for UCI multiplexing within the slot.

In some implementations, duplex mode may be used to enhance coverage or reduce delay. For example, in the TDD band (or unpaired spectrum), sub-band non-overlapping full duplex is adopted. The sub-band non-overlapping full duplex refers to dividing a bandwidth (for example, carrier bandwidth) of a base station into more than one sub-band, and simultaneously performing uplink and downlink communication in different sub-bands. The base station can flexibly change the uplink/downlink ratio in different sub-bands by using the sub-band non-overlapping full duplex technology, for example, by allocating a sub-band as full uplink (or full downlink), or increase/decrease the uplink/downlink ratio of a sub-band. In this manner, the opportunity of uplink transmission/downlink reception of the terminal device in time domain is increased, thereby enhancing the coverage capacity of the terminal device in the system and/or reducing the transmission delay of the terminal device.

For example, the UE may determine a PUSCH for UCI multiplexing by performing the following procedure on candidate PUSCHs: if the candidate PUSCHs include first PUSCH(s) (for example, the first PUSCH may be a PUSCH scheduled by a DCI format) and second PUSCH(s) (for example, the second PUSCH may be a PUSCH configured by respective ConfiguredGrantConfig and/or semi-PersistentOnPUSCH), and the UE would multiplex UCI in one of the candidate PUSCHs, and the candidate PUSCHs satisfy the UCI multiplexing conditions, the UE multiplexes the UCI in a PUSCH from the first PUSCHs.

In the following description, for convenience, the term “first PUSCH” may refer to a PUSCH scheduled by a DCI format, and the term “second PUSCH” may refer to a PUSCH not scheduled by a DCI format, such as a PUSCH configured by respective higher layer parameters (such as ConfiguredGrantConfig and/or semi-PersistentOnPUSCH), and the term “third PUSCH” may refer to a PUSCH that is transmitted simultaneously with another PUSCH overlapping in time domain with the PUSCH on a same serving cell or a same BWP (or, the “third PUSCH” may refer to a PUSCH that support simultaneous transmission with another PUSCH overlapping in time domain with the PUSCH on a same serving cell or a same BWP), the term “fourth PUSCH” may refer to a PUSCH that does not overlap in time domain with a PUSCH on a same serving cell or a same BWP (or, the “fourth PUSCH” may refer to a PUSCH that does not support simultaneous transmission with another PUSCH overlapping in time domain with the PUSCH on a same serving cell or a same BWP). It should be noted that the “first PUSCH” and “second PUSCH” are not mutually exclusive with the “third PUSCH” and “fourth PUSCH”. For example, a PUSCH may be the first PUSCH, and at the same time it may be the “third PUSCH” or “fourth PUSCH”. For another example, a PUSCH may be the third PUSCH, and at the same time it may be the “first PUSCH” or “second PUSCH”.

It should be noted that, alternatively, the term “third PUSCH” may also refer to a PUSCH transmitted in a sub-band. For example, time domain resources (symbols) of the PUSCH are all in time domain resources (symbols) occupied by the sub-band, or at least one time domain resource (symbol) of the PUSCH is in time domain resources (symbols) occupied by the sub-band. The term “fourth PUSCH” may also refer to a PUSCH transmitted in a full bandwidth (non-sub-band). For example, time domain resources (symbols) of the PUSCH are all in time domain resources (symbols) occupied by the full bandwidth (non-sub-band), or at least one time domain resource (symbol) of the PUSCH is in time domain resources (symbols) occupied by the full bandwidth (non-sub-band).

In some cases, the UE may transmit two or more PUSCHs simultaneously (two PUSCHs are taken as an example for illustration below). For example, the two PUSCHs may be on a same serving cell. For another example, the two PUSCHs may be on a same BWP. For another example, the two PUSCHs may be associated with two different TRPs/panels/beams. For another example, the UE may transmit the two PUSCHs through two different panels. The UE may be configured or indicated that two PUSCHs (for example, two PUSCHs on a serving cell or a BWP) are transmitted simultaneously. In this case, the UE can transmit two PUSCHs simultaneously or is allowed to transmit two PUSCHs simultaneously. In some examples, the UE may be configured with a first parameter, which may be a parameter indicating simultaneous transmission of two PUSCHs (e.g., two PUSCHs on a serving cell or a BWP). If the UE is configured with the first parameter, the UE may transmit two PUSCHs simultaneously. In some examples, the UE may be configured by a PDCCH configuration parameter (e.g., higher layer signaling parameter PDCCH-Config), where the PDCCH configuration parameter (e.g., higher layer signaling parameter PDCCH-Config) contains two different CORESET pool index parameter (e.g., coresetPoolIndex) values (e.g., value 0 and value 1). In this case, the UE can transmit two PUSCHs on a serving cell or a BWP (for example, the two PUSCHs may correspond to different CORESET pool index parameter (e.g., coresetPoolIndex) values) simultaneously. The configuration control resource set parameter may be a configuration control resource set parameter for an active BWP of a serving cell. In some examples, the UE may be configured or provided with an SRS resource set index parameter (e.g., SRS_resource_set_index) with two different values (e.g., value 0 and value 1). A first SRS resource set (an SRS resource set index parameter value of 0) may correspond to the CORESET pool index parameter value of 0, and another SRS resource set (the SRS resource set index parameter value of 1) may correspond to the CORESET pool index parameter value of 1. In this case, the UE can transmit two PUSCHs on a serving cell or a BWP (for example, the two PUSCHs may correspond to different SRS resource set index parameter (e.g., SRS_resource_set_index) values) simultaneously. The configuration of multi-panel/multi-antenna/multi-beam uplink transmission for the UE is described above by the example of the SRS resource set index parameter and CORESET pool index parameter. However, the embodiments of the disclosure are not limited thereto, and it may be configured by other parameters associated with the uplink (e.g., PUSCH) transmission. Although the simultaneous transmission of two PUSCHs is described above, the embodiments of the disclosure are not limited thereto, and a similar method may be used for configuring (for example, configuring N CORESET pool index parameter values, where N is an integer equal to or greater than 2), so that the UE can transmit or supports simultaneous transmission of N PUSCHs.

In embodiments of the disclosure, the term “panel” may refer to a group of antenna ports or an antenna group. An uplink transmission configuration indicator (TCI) of each antenna panel may be used to indicate a beam for the antenna panel, which may be a beam associated with the indicated reference signal identity (ID). An SRS set ID may be used to indicate an antenna panel ID, where each antenna panel is associated with one SRS set.

In some implementations, the UE may receive downlink control signaling (including physical layer signaling and/or higher layer signaling). The downlink control signaling may configure/indicate the UE to transmit one or more PUSCHs and/or one or more PUCCHs. The one or more PUSCHs include third PUSCH(s), where the third PUSCH is a PUSCH that is transmitted simultaneously with another PUSCH overlapping in time domain with the PUSCH on a same serving cell or a same BWP (or, the third PUSCH is a PUSCH that supports simultaneous transmission with another PUSCH overlapping in time domain with the PUSCH on a same serving cell or a same BWP). The PUCCH overlaps with at least one of the third PUSCH(s) in time domain. When the PUCCH overlaps with more than one PUSCH in time domain, the UE multiplexes UCI (e.g., HARQ-ACK and/or CSI) of the PUCCH in at least one PUSCH based on the CORESET pool index parameter (e.g., coresetPoolIndex), and the UE does not transmit the PUCCH.

The UCI may be multiplexed based on at least one of the following manners MN1-MN7.

Manner MN1

In manner MN1, the UE may multiplex the UCI of the PUCCH in one PUSCH. The PUSCH may be a third PUSCH or a fourth PUSCH. The fourth PUSCH is a PUSCH that does not overlap in time domain with another PUSCH on a same serving cell or a same BWP (or, the fourth PUSCH is a PUSCH that does not support simultaneous transmission with another PUSCH overlapping in time domain with the PUSCH on a same serving cell or a same BWP). For example, the PUSCH may be determined based on at least one of the following manners MN2-MN4.

The method is simple to implement and can reduce the implementation complexity of the UE and the base station.

Manner MN2

In manner MN2, if the PUCCH overlaps with two PUSCHs on a same serving cell or a same BWP in time domain, where the two PUSCHs have the same starting symbol (or starting position), the UE may multiplex the UCI (e.g., HARQ-ACK and/or CSI) of the PUCCH in a PUSCH with a smaller CORESET pool index parameter (e.g., coresetPoolIndex) value (or the CORESET pool index parameter (e.g., coresetPoolIndex) value of 0). Or, if the PUCCH overlaps in time domain with two PUSCHs on a same serving cell or a same BWP, where the two PUSCHs have the same starting symbol (or starting position), the UE multiplexes the UCI (e.g., HARQ-ACK and/or CSI) of the PUCCH in a PUSCH with a larger CORESET pool index parameter (e.g., coresetPoolIndex) value (or the CORESET pool index parameter (e.g., coresetPoolIndex) value of 1).

In some implementations, the UE may determine a PUSCH for UCI multiplexing by performing the following procedures on candidate PUSCHs (for example, the candidate PUSCHs determined according to various embodiments of the disclosure):

if the candidate PUSCHs include first PUSCHs (for example, the first PUSCHs may be PUSCHs scheduled by DCI formats) and second PUSCHs (for example, the second PUSCHs may be PUSCHs configured by respective ConfiguredGrantConfig and/or semi-PersistentOnPUSCH), and the UE would multiplex UCI in one of the candidate PUSCHs, and the candidate PUSCHs satisfy UCI multiplexing conditions (for example, timeline conditions for UCI multiplexing; for another example, UCI multiplexing conditions defined in various embodiments of the disclosure), the UE multiplexes the UCI in a PUSCH from the first PUSCHs.

if the UE would multiplex the UCI in one of the candidate PUSCHs and the UE does not multiplex aperiodic CSI in any of the candidate PUSCHs, the UE multiplexes the UCI in a PUSCH of a serving cell with a smallest serving cell index (for example, a parameter ServCellIndex) subject to the UCI multiplexing conditions. If the UE transmits more than one PUSCH in a slot on a serving cell with a smallest serving cell index that satisfy the UCI multiplexing conditions, the UE multiplexes the UCI in an earliest PUSCH transmitted by the UE in the slot. If the earliest PUSCH includes more than one (or, two or more) PUSCH, the UE multiplexes the UCI in a PUSCH with a smaller CORESET pool index parameter (e.g., coresetPoolIndex) value (or the CORESET pool index parameter (e.g., coresetPoolIndex) value of 0).

In some implementations, the UE may determine a PUSCH for UCI multiplexing by performing the following procedures on candidate PUSCHs (for example, the candidate PUSCHs determined by various embodiments of the disclosure):

if the candidate PUSCHs include fifth PUSCHs (for example, the fifth PUSCHs may be PUSCHs with a CORESET pool index parameter (e.g., coresetPoolIndex) value of 0) and sixth PUSCHs (for example, the sixth PUSCHs may be PUSCHs with a CORESET pool index parameter (e.g., coresetPoolIndex) value of 1), and the UE would multiplex the UCI in one of the candidate PUSCHs, and the candidate PUSCHs satisfy UCI multiplexing conditions (for example, timeline conditions for UCI multiplexing; for another example, UCI multiplexing conditions defined in other embodiments of the disclosure), the UE multiplexes the UCI in a PUSCH from the fifth PUSCHs (or the sixth PUSCHs).

if the candidate PUSCHs include first PUSCHs (for example, the first PUSCHs may be PUSCHs scheduled by DCI formats) and second PUSCHs (for example, the second PUSCHs may be PUSCHs configured by respective ConfiguredGrantConfig and/or semi-PersistentOnPUSCH), and the UE would multiplex the UCI in one of the candidate PUSCHs, and the candidate PUSCHs satisfy UCI multiplexing conditions (for example, timeline conditions for UCI multiplexing; for another example, UCI multiplexing conditions defined in other embodiments of the disclosure), the UE multiplexes the UCI in a PUSCH from the first PUSCHs.

if the UE would multiplex the UCI in one of the candidate PUSCHs and the UE does not multiplex aperiodic CSI in any of the candidate PUSCHs, the UE multiplexes the UCI in a PUSCH on a serving cell with a smallest serving cell index (for example, a parameter ServCellIndex) subject to the UCI multiplexing conditions. If the UE transmits more than one PUSCH in a slot on a serving cell with a smallest serving cell index satisfying the UCI multiplexing conditions, the UE multiplexes the UCI in an earliest PUSCH transmitted by the UE in the slot.

It should be noted that the above three ordering rules can also be combined in any order.

The method clarifies the behavior of the UE for UCI multiplexing when two PUSCHs are scheduled on a same serving cell at the same time, which can improve the reliability of uplink transmission. In addition, the method can enable the base station to schedule two PUSCHs at the same time on a same serving cell, so that the scheduling flexibility can be improved and the system spectrum efficiency can be improved.

Manner MN3

In manner MN3, if the candidate PUSCHs include third PUSCHs and fourth PUSCHs, and the UE would multiplex the UCI in one of the candidate PUSCHs, and the candidate PUSCHs satisfy UCI multiplexing conditions (for example, timeline conditions for UCI multiplexing; for another example; UCI multiplexing conditions defined in other embodiments of the disclosure), the UE multiplexes the UCI in a PUSCH from the third PUSCHs (or the fourth PUSCHs).

In some examples, the multiplexing the UCI in a PUSCH from the third PUSCHs may include multiplexing the UCI in a PUSCH from the third PUSCHs with a smaller CORESET pool index parameter (e.g., coresetPoolIndex) value (or a CORESET pool index parameter (e.g., coresetPoolIndex) value of 0). Or, the multiplexing the UCI in a PUSCH from the third PUSCHs may include multiplexing the UCI in a PUSCH from the third PUSCHs with a larger CORESET pool index parameter (e.g., coresetPoolIndex) value (or a CORESET pool index parameter (e.g., coresetPoolIndex) value of 1). More detailed implementations may refer to the description of manner MN2.

In some examples, the multiplexing the UCI in a PUSCH from the fourth PUSCHs may include multiplexing the UCI in a PUSCH from the fourth PUSCHs with a smaller CORESET pool index parameter (e.g., coresetPoolIndex) value (or a CORESET pool index parameter (e.g., coresetPoolIndex) value of 0). Or, the multiplexing the UCI in a PUSCH from the fourth PUSCHs may include multiplexing the UCI in a PUSCH from the fourth PUSCHs with a larger CORESET pool index parameter (e.g., coresetPoolIndex) value (or a CORESET pool index parameter (e.g., coresetPoolIndex) value of 1). More detailed implementations may refer to the description of manner MN2.

The method is simple to implement and can reduce the implementation complexity of the UE and the base station.

Manner MN4

In manner MN4, if a PUCCH overlaps in time domain with two PUSCHs on a same serving cell or a same BWP, where the two PUSCHs have the same starting symbol (or starting position), the UE may multiplex the UCI (e.g., HARQ-ACK and/or CSI) of the PUCCH in a PUSCH that has a same CORESET pool index parameter (e.g., coresetPoolIndex) as the PUCCH (or the UCI of the PUCCH).

The method is simple to implement and can reduce the implementation complexity of the UE and the base station.

Manner MN5

When a PUCCH overlaps with two third PUSCHs overlapping in time domain on a same serving cell or a same BWP, the UE may multiplex the UCI of the PUCCH in the two third PUSCHs.

The method is simple to implement and can reduce the implementation complexity of the UE and the base station.

Manner MN6

According to some embodiments of manner MN6, the UE may be configured or provided with a configuration for indicating a number of resources or a scaling of resources on a PUSCH that are allocated to UCI when the UCI is multiplexed in a third PUSCH.

In some implementations, if the UE can multiplex UCI in a third PUSCH, a configuration parameter of the UCI in a PUSCH (e.g., uci-OnPUSCH) may be configured by a second parameter. The second parameter may be used to indicate a beta offset parameter (for example, betaOffset, which may be selected from ‘dynamic’ or ‘semiStatic’) and/or a scaling parameter (for example, scaling or alpha, which indicates a scaling factor of a number of resources (e.g., resource elements (REs)) limited on the PUSCH that are allocated to the UCI) by which the UCI is multiplexed in the third PUSCH. If the UE is configured with the second parameter, when the UE multiplexes the UCI in the third PUSCH, the UE may determine a number of REs occupied by the UCI according to the second parameter. If the UE is configured with the second parameter, when the UE multiplexes the UCI in the fourth PUSCH, the UE may determine the number of REs occupied by the UCI according to the configuration parameter of the UCI (for example, uci-OnPUSCH, uci-OnPUSCH-ListDCI-0-1 or uci-OnPUSCH-ListDCI-0-2). If the UE is not configured with the second parameter, when the UE multiplexes the UCI in the third PUSCH, the UE may determine the number of REs occupied by the UCI according to the configuration parameter of the UCI (for example, uci-OnPUSCH, uci-OnPUSCH-ListDCI-0-1 or uci-OnPUSCH-ListDCI-0-2). The second parameter may include at least one of uci-OnPUSCH, uci-OnPUSCH-ListDCI-0-1 and uci-OnPUSCH-ListDCI-0-2.

In an example, the UE may be configured with a second uci-OnPUSCH, which is used to indicate the configuration parameter of the UCI (e.g., a number or scaling of resources on the PUSCH that are allocated to the UCI) by which the UCI is multiplexed in the third PUSCH.

In an example, the UE may be configured with a second uci-OnPUSCH-ListDCI-0-1. The second uci-OnPUSCH-ListDCI-0-1 may include two uci-OnPUSCH, which correspond to the configuration parameter (e.g., the number or scaling of resources allocated to the UCI on the PUSCH) of the UCI by which HARQ-ACK with a lower priority is multiplexed in the third PUSCH scheduled by DCI format 0-1, and the configuration parameter by which HARQ-ACK with a higher priority is multiplexed in the third PUSCH scheduled by DCI format 0-1, respectively.

In an example, the UE may be configured with a second uci-OnPUSCH-ListDCI-0-2. The second uci-OnPUSCH-ListDCI-0-2 may include two uci-OnPUSCH-DCI-0-2, which correspond to the configuration parameter (e.g., the number of resources allocated to the UCI on the PUSCH) of the UCI by which HARQ-ACK with a lower priority is multiplexed in the third PUSCH scheduled by DCI format 0-2, and the configuration parameter by which HARQ-ACK with a higher priority is multiplexed in the third PUSCH scheduled by DCI format 0-2, respectively.

The method according to manner MN6 can improve the scheduling flexibility by configuring the separate configuration parameters of the UCI, thereby improving the performance of uplink scheduling.

Manner MN7

According to some embodiments of manner MN7, if the UE indicates a corresponding capability of multiplexing HARQ-ACK in a PUSCH when there is no PUCCH (e.g., mux-HARQ-ACK-withoutPUCCH-onPUSCH) and transmits multiple PUSCHs (e.g., multiple PUSCHs on respective multiple serving cells) in a slot (e.g., a slot for PUCCH transmission), and the UE does not determine any PUCCH carrying HARQ-ACK information in the slot and at least one of the multiple PUSCHs is scheduled by a DCI format that includes a DAI field, the UE selects the PUSCHs from all the multiple PUSCHs in the slot as candidate PUSCHs for HARQ-ACK multiplexing in the slot other than at least one of the following PUSCHs,

in case that the UE is configured with a PDSCH HARQ-ACK codebook parameter (e.g., pdsch-HARQ-ACK-Codebook) as dynamic or a R16 PDSCH HARQ-ACK codebook parameter (e.g., pdsch-HARQ-ACK-Codebook-r16), any PUSCH scheduled by a DCI format with a DAI field that is equal to 4,

in case that the UE is configured with the PDSCH HARQ-ACK codebook parameter (e.g., pdsch-HARQ-ACK-Codebook) as semi-static, any PUSCH scheduled by a DCI format with a DAI field that is equal to 0,

a PUSCH scheduled by a DCI format that does not include a DAI field, for example, a PUSCH scheduled by a DCI format 0_0,

a PUSCH not scheduled by a DCI format, for example, a PUSCH configured by ConfiguredGrantConfig and/or semi-PersistentOnPUSCH, and

a PUSCH configured (or indicated) with a transmission with repetitions. For example, a PUSCH is repeatedly transmitted in multiple slots.

One of more than one PUSCH scheduled by a DCI format. For example, the more than one PUSCH is transmitted in multiple slots (e.g., slots for PUCCH transmission).

In an example, if the UE indicates a corresponding capability of multiplexing HARQ-ACK in a PUSCH when there is no PUCCH (e.g., mux-HARQ-ACK-withoutPUCCH-onPUSCH) and transmits multiple PUSCHs (e.g., multiple PUSCHs in respective multiple serving cells) in a slot (e.g., a slot for PUCCH transmission), and the UE does not determine any PUCCH carrying HARQ-ACK information in the slot and at least one of the multiple PUSCHs is scheduled by a DCI format including a DAI field, the UE selects the PUSCHs from all of the multiple PUSCHs in the slot as candidate PUSCHs for HARQ-ACK multiplexing in the slot other than the following PUSCHs,

in case that the UE is configured with a HARQ-ACK codebook parameter of a PDSCH (e.g., pdsch-HARQ-ACK-Codebook) as dynamic or a R16 PDSCH HARQ-ACK codebook parameter (e.g., pdsch-HARQ-ACK-Codebook-r16), any PUSCH scheduled by a DCI format with a DAI field that is equal to 4,

in case that the UE is configured with the PDSCH HARQ-ACK codebook parameter (e.g., pdsch-HARQ-ACK-Codebook) as semi-static, any PUSCH scheduled by a DCI format with a DAI field that is equal to 0, and

a PUSCH scheduled by a DCI format that does not include a DAI field, for example, a PUSCH scheduled by a DCI format 0_0.

In this way, the HARQ-ACK information can be multiplexed in the PUSCH that the base station expects the UE to multiplex, which can improve the reliability of uplink transmission, avoid blind detection of the base station and reduce the implementation complexity of the base station.

It should be noted that the method in the embodiments of the disclosure may also be determined based on different conditions. In some implementations, if the UE is configured with an ACK NACK feedback mode (ackNackFeedbackMode) as joint, the PUSCH may be determined according to manner MN3. For example, it may first resolve overlapping among PUCCHs, and then resolve overlapping among PUCCHs and PUSCHs according to manner MN3. If the UE is configured with the ACK NACK feedback mode (ackNackFeedbackMode) as separate, the PUSCH may be determined according to manner MN4. For example, it may first resolve overlapping among PUCCHs with a same CORESET pool index parameter (e.g., coresetPoolIndex), and then resolve overlapping among PUCCHs and PUSCHs with a same CORESET pool index parameter (e.g., coresetPoolIndex). Or, it may also be indicated by a new RRC parameter that one of manner MN3 or MN4 is used. For example, if the UE is configured (or not configured) with the RRC parameter, the PUSCH may be determined according to manner MN3, otherwise, if the UE is not configured (or configured) with the RRC parameter, the PUSCH may be determined according to manner MN4. This can improve the flexibility of network configuration.

The implementation MN4 also needs to define corresponding CORESET pool indexes for all UCI information and/or PUCCH resources. At least one of the following methods MN16-MN19 may be adopted.

Manner MN16

The CORESET pool index parameter (e.g., coresetPoolIndex) is configured in a PUCCH resource configuration parameter (e.g., PUCCH-Resource). The method is simple to implement.

Manner MN17

The CORESET pool index parameter (e.g., coresetPoolIndex) for SR is configured in an SR configuration parameter (e.g., SchedulingRequestConfig) or logical channel configuration parameter (e.g., LogicalChannelConfig).

Manner MN18

The CORESET pool index parameter (e.g., coresetPoolIndex) for CSI resources is configured in a CSI resource configuration parameter (e.g., CSI-ResourceConfig).

Manner MN19

The CORESET pool index parameter (e.g., coresetPoolIndex) for CSI reporting is configured in a CSI reporting configuration parameter (CSI-ReportConfig).

This can improve the reliability of uplink transmission, and avoid that it is not an idea backhaul link before a TRP and the TRP cannot receive its UCI information.

In some implementations, after the UE first resolves overlapping among PUCCHs with the same CORESET pool index parameter (e.g., coresetPoolIndex) and then resolves overlapping among PUCCHs and PUSCHs with a same CORESET pool index parameter (e.g., coresetPoolIndex), if there is overlapping among a PUCCH and a PUSCH and the PUCCH and the PUSCH have the same priority, a PUCCH and/or PUSCH for transmission may be determined according to at least one of the following manners MN20-MN21, or the UE does not expect that there is overlapping among a PUCCH and a PUSCH.

Manner MN20

If a PUCCH with an SR overlaps with a PUSCH in time domain, the UE transmits the PUSCH regardless of whether the PUCCH is configured or indicated with a transmission with repetitions. The UE does not transmit the PUCCH, or defers the transmission of the PUCCH. For example, if the PUCCH is configured with the transmission with repetitions, the UE does not transmit the repetition of the PUCCH transmission, or defers the transmission of the repetition of the PUCCH transmission. For example, if the PUCCH is not configured with the transmission with repetitions, the UE does not transmit the PUCCH.

The method is also applicable to CSI, for example, by replacing the “SR” with “CSI”.

This can improve the reliability of uplink data transmission.

Manner MN21

If a PUCCH with HARQ-ACK overlaps with a PUSCH in time domain, the UE transmits the PUCCH with HARQ-ACK, and the UE does not transmit the PUSCH. This can improve the reliability of HARQ-ACK transmission.

If a PUSCH overlaps with a PUCCH with HARQ-ACK and a PUCCH with SR and/or CSI in time domain, the UE may first resolve the conflict among the PUSCH and the PUCCH with HARQ-ACK. For example, the UE does not transmit the PUSCH, and if the PUCCH with SR and/or CSI does not overlap with other PUSCHs at this time, the UE may transmit the PUCCH with SR and/or CSI. This can improve the reliability of UCI transmission.

Manner MN8

According to some embodiments of manner MN8, for any HARQ process ID for a given CORESET pool index parameter (e.g., coresetPoolIndex) value in a given scheduled cell, the UE is not expected to transmit a PUSCH that overlaps in time with another PUSCH. Except that the UE is configured with a control resource set parameter (e.g., ControlResourceSet) including two different CORESET pool index parameter (e.g., coresetPoolIndex) values by a PDCCH configuration parameter (e.g., a higher layer signaling parameter PDCCH-Config), for any given HARQ process ID in a given scheduled cell, the UE is not expected to transmit a PUSCH that overlaps with another PUSCH in time. If the UE is configured with a control resource set parameter (e.g., ControlResourceSet) including two different CORESET pool index parameter (e.g., coresetPoolIndex) values by a PDCCH configuration parameter (e.g., a higher layer signaling parameter PDCCH-Config), for any HARQ process ID for a given CORESET pool index parameter (e.g., coresetPoolIndex) value in a given scheduled cell, the UE is not expected to transmit a PUSCH that overlaps in time with another PUSCH. The configuration of the control resource set parameter may be the configuration of the control resource set parameter for an active BWP of a serving cell.

The method can reduce the implementation complexity of the UE.

Manner MN9

According to some embodiments of manner MN9, except that the UE is configured with a control resource set parameter (e.g., ControlResourceSet) including two different CORESET pool index parameter (e.g., coresetPoolIndex) values by a PDCCH configuration parameter (e.g., a higher layer signaling parameter PDCCH-Config) and/or two PUSCHs are associated with different CORESET pool index parameter (e.g., coresetPoolIndex) values, the UE is not expected to be scheduled by a PDCCH ending in a symbol i to transmit a PUSCH on a given serving cell overlapping in time with a transmission occasion, where the UE is allowed to transmit a PUSCH with configured grant in the transmission occasion, starting in a symbol j on the same serving cell if the end of the symbol i is not at least N₂ symbols before the beginning of the symbol j, if the UE is not provided with a low-priority DG high-priority CG parameter (for example, prioLowDG-HighCG) or high-priority DG low-priority CG parameter (for example, prioHighDG-LowCG), or the UE is provided with a low-priority DG high-priority CG parameter (for example, prioLowDG-HighCG) or high-priority DG low-priority CG parameter (for example, prioHighDG-LowCG) and the two PUSCHs have the same priority index. The configuration control resource set parameter may be a configuration control resource set parameter for an active BWP of a serving cell.

Manner MN10

According to some embodiments of manner MN10, for each serving cell and each configured uplink grant, if configured and activated, a MAC entity shall:

1> if the MAC entity is not configured with a logical channel-based prioritization parameter (e.g., a parameter Ich-basedPrioritization), and the PUSCH duration of the configured uplink grant does not overlap with the PUSCH duration of an uplink grant received on the PDCCH for the serving cell, and the CORESET pool index parameter (e.g., coresetPoolIndex) is not configured, or the CORESET pool index parameter (e.g., coresetPoolIndex) is configured and the PUSCHs are associated with the same CORESET pool index parameter (e.g., coresetPoolIndex) value:

2> set the HARQ process ID to the HARQ process ID associated with the PUSCH duration

2—> if a CG retransmission timer parameter (for example, cg-RetransmissionTimer) of the corresponding HARQ process is configured and not running, then for the corresponding HARQ process:

3> if the configured grant timer parameter (for example, ConfiguredGrantTimer) is not running and the HARQ process is not pending (i.e., new transmission):

4> consider the NDI bit to have been toggled;

4> deliver the configured uplink grant and the associated HARQ information to the HARQ entity.

3> else if the previous uplink grant delivered to the HARQ entity for the same HARQ process was a configured uplink grant (i.e., retransmission on the configured grant):

4> deliver the configured uplink grant and the associated HARQ information to the HARQ entity.

The method can avoid a situation where a CG PUSCH is cancelled by a PUSCH with dynamical scheduling that has a different CORESET pool index parameter from that of the CG PUSCH, which can improve the opportunity of uplink transmission, reduce the uplink transmission delay and improve the system spectrum efficiency.

Manner MN11

According to some embodiments of manner MN11, when a MAC entity is configured with a logical channel-based prioritization parameter (e.g., a parameter Ich-basedPrioritization), for each uplink grant delivered to a HARQ entity and whose associated PUSCH can be transmitted by lower layers, the MAC entity shall:

1> if the uplink grant is a configured uplink grant.

2> if there is no overlapping PUSCH duration of another configured uplink grant which was not already de-prioritized, in the same BWP, whose priority is higher than the priority of the uplink grant, and the CORESET pool index parameter (e.g., coresetPoolIndex) is not configured, or the CORESET pool index parameter (e.g., coresetPoolIndex) is configured and the PUSCHs are associated with the same CORESET pool index parameter (e.g., coresetPoolIndex) value; and

2> if there is no overlapping PUSCH duration of a dynamic uplink grant (for example, uplink grant addressed to CS-RNTI with NDI=1 or C-RNTI) which was not already de-prioritized, in the same BWP, whose priority is higher than or equal to the priority of the uplink grant, and the CORESET pool index parameter (e.g., coresetPoolIndex) is not configured, or the CORESET pool index parameter (e.g., coresetPoolIndex) is configured and the PUSCH of the uplink grant and the PUSCH of the dynamic uplink grant are associated with the same CORESET pool index parameter (e.g., coresetPoolIndex) value; and

2> if there is no overlapping PUCCH resource with an SR transmission which was not already de-prioritized and the simultaneous transmission of the SR and the uplink grant is not allowed by configuration of a PUCCH (or SR) and PUSCH simultaneous transmission parameter (for example, simultaneousPUCCH-PUSCH or simultaneousPUCCH-PUSCH-SecondaryPUCCHgroup or simultaneousSR-PUSCH-diffPUCCH-Groups), and the priority of the logical channel that triggered the SR is higher than the priority of the uplink grant:

3> consider the uplink grant as a prioritized uplink grant;

3> if the CORESET pool index parameter (e.g., coresetPoolIndex) is not configured, consider other overlapping uplink grants (if any) as de-prioritized uplink grants;

3> if the CORESET pool index parameter (e.g., coresetPoolIndex) is configured, consider the other overlapping uplink grant(s) (if any) with the same CORESET pool index parameter (e.g., coresetPoolIndex) value as that of the uplink grant PUSCH as de-prioritized uplink grants;

3> consider the other overlapping SR transmission(s), if any, as a de-prioritized SR transmissions, except for the SR transmission(s) whose simultaneous transmission is allowed by configuration of the PUCCH (or SR) and PUSCH simultaneous transmission parameter (for example, simultaneousPUCCH-PUSCH or simultaneousPUCCH-PUSCH-SecondaryPUCCHgroup or simultaneousSR-PUSCH-diffPUCCH-Groups).

The method can avoid a situation where the transmission of a PUSCH with a lower priority or a PUCCH carrying SR is cancelled by a PUSCH with a higher priority or a PUCCH carrying SR that has a different CORESET pool index parameter, which can improve the opportunity of uplink transmission with a lower priority, reduce the uplink transmission delay and improve the system spectrum efficiency.

Manner MN12

According to some embodiments of manner MN12, for each uplink grant, the HARQ entity will

1> identify a HARQ process associated with the grant, and for each identified HARQ process:

2> if it is a retransmission

3> if the MAC entity is not configured with a logical channel-based prioritization parameter (e.g., a parameter Ich-basedPrioritization) and the uplink grant is a part of a bundle of the configured uplink grant, and the PUSCH duration of the uplink grant overlaps with a PUSCH duration of another uplink grant received on the PDCCH, and the CORESET pool index parameter (e.g., coresetPoolIndex) is not configured, or the CORESET pool index parameter (e.g., coresetPoolIndex) is configured and the PUSCH of the configured uplink grant and the PUSCH of the another uplink grant received on the PDCCH are associated with the same CORESET pool index parameter (e.g., coresetPoolIndex) value;

4> ignore the uplink grant

The method can avoid a situation where a CG PUSCH is cancelled by a PUSCH with dynamical scheduling that has a different CORESET pool index parameter from that of the CG PUSCH, which can improve the opportunity of uplink transmission, reduce the uplink transmission delay and improve the system spectrum efficiency.

Manner MN13

According to some embodiments of manner MN13, HARQ retransmission may be performed on the same CORESET pool index parameter (e.g., coresetPoolIndex) value. When the UE receives a DCI format indicating to schedule a PUSCH, the UE determines a CORESET pool index parameter (e.g., coresetPoolIndex) value according to an indication in the DCI. If an NDI in the DCI format is the same as the determined CORESET pool index parameter (e.g., coresetPoolIndex) value and an NDI in the previous DCI format with the same HARQ ID, the UE considers the scheduled PUSCH transmission as a retransmission, otherwise (the NDI is different), the UE considers the scheduled PUSCH transmission as a new transmission.

The method can increase the number of HARQ processes dynamically indicated by the DCI under the premise of not increasing the number of DCI bits, which can improve the scheduling flexibility.

Manner MN14

According to some embodiments of manner MN14, a CG PUSCH configuration may be configured separately for different CORESET pool index parameter (e.g., coresetPoolIndex) values. For example, when the CORESET pool index parameter (e.g., coresetPoolIndex) is with a value of 1, at least one of the following parameters may be additionally configured,

a parameter regarding a list of configured grant configurations to be added (for example, ConfiguredGrantConfigToAddModList),

a parameter regarding a list of configured grant configurations to be released (for example, ConfiguredGrantConfigToReleaseList),

a parameter regarding deactivation of configured grant Type-2 configurations (for example, ConfiguredGrantConfigType2DeactivationState), and

a parameter regarding a list of configured grant Type-2 configurations to be deactivated (for example, ConfiguredGrantConfigType2DeactivationStateList).

When the UE receives a DCI format indicating activation of Type-2 configured grants, the UE determines a CORESET pool index parameter (e.g., coresetPoolIndex) value according to an indication in the DCI, and a Type-2 configured grant corresponding to the determined CORESET pool index parameter (e.g., coresetPoolIndex) value is activated.

When the UE receives a DCI format indicating release of Type-2 configured grants, the UE determines a CORESET pool index parameter (e.g., coresetPoolIndex) value according to an indication in the DCI, and one or more Type-2 configured grants corresponding to the determined CORESET pool index parameter (e.g., coresetPoolIndex) value is deactivated.

The method can increase the number of Type-2 configured grants dynamically indicated by the DCI under the premise of not increasing the number of DCI bits, which can improve the scheduling flexibility.

It should be noted that the method for the UE to simultaneously transmit two PUSCHs according to the embodiments of the disclosure may also be applicable to the method for the UE to simultaneously transmit N PUSCHs, where N is an integer greater than 2.

It should be noted that the CORESET pool index parameter in the embodiments of the disclosure may be understood as a parameter related to TRP. For example, a value of a CORESET pool index corresponds to a TRP. The ‘CORESET pool index parameter’ may also be replaced with the ‘SRS resource set index parameter’ (e.g., SRS_resource_set_index). The first SRS resource set (SRS resource set index parameter value of 0) corresponds to the CORESET pool index parameter value of 0, and another SRS resource set (SRS resource set index parameter value of 1) corresponds to the CORESET pool index parameter value of 1.

In new wireless communication systems, a UE can support two transmission waveform modes during uplink transmission, that is, the UE can use two transmission waveform modes (including OFDM (Orthogonal Frequency Division Multiplexing) and DFT-s-OFDM (Discrete Fourier Transform-Spread-Orthogonal Frequency Division Multiplexing)) for uplink transmission. Generally, the UE determines the transmission waveform mode to be used according to the (semi-static) configuration of the base station. However, because the position of the UE may change and the channel conditions may also change during the mobile communication, the waveform switching of a PUSCH can be dynamically indicated by a DCI format. For example, the UE may be configured a parameter to support waveform dynamic switching of a PUSCH. When a PUSCH is scheduled by an uplink DCI format (for example, DCI format 0_2, 0_1), the waveform used by the PUSCH may be dynamically indicated through a new field in the DCI format.

When a PUCCH overlaps with two PUSCHs in time domain, if waveforms of the two PUSCHs are different, how to multiplex UCI is a problem to be solved. For example, manner MN15 may be used to determine the PUSCH for UCI multiplexing.

Manner MN15

In manner MN15, the UE may be configured with a parameter to support waveform dynamic switching of a PUSCH. If a PUCCH overlaps with at least two PUSCHs in time domain, where the waveforms of the PUSCHs are different, at least one of manners MN1-MN6 may be used to multiplex UCI of the PUCCH in the PUSCH, and the third PUSCH in manners MN1-MN6 may be redefined as a PUSCH with an OFDM waveform, and the fourth PUSCH may be redefined as a PUSCH with a DFT-s-OFDM waveform. Alternatively, the fourth PUSCH in MN1-MN6 may be redefined as a PUSCH with an OFDM waveform, and the third PUSCH may be redefined as a PUSCH with a DFT-s-OFDM waveform.

In an example, the UE may preferentially multiplex the UCI in the PUSCH with the OFDM waveform, which can improve the reliability of UCI transmission because the OFDM waveform is generally used in the case of good channel state.

In an example, a beta offset parameter (for example, betaOffset, which may be selected from ‘dynamic’ or ‘semiStatic’) and/or a scaling parameter (for example, scaling or alpha, which indicates a scaling factor of a number of resources (e.g., resource elements (REs)) limited on the PUSCH that are allocated to the UCI) when the UCI is multiplexed in PUSCHs with different waveforms may be configured by different parameters. For example, it may be specified by protocols or configured by higher layer signaling that, a parameter UCI-OnPUSCH in PUSCH-Config may be used to multiplex the UCI in the third PUSCH, and a second UCI-OnPUSCH may be additionally configured for multiplexing the UCI in the fourth PUSCH. Or, a list of UCI-OnPUSCH may be configured, where the first UCI-OnPUSCH in the list may be used to multiplex the UCI in the third PUSCH, and the second UCI-OnPUSCH in the list may be used to multiplex the UCI in the fourth PUSCH.

This method can improve the scheduling flexibility and improve the system spectrum efficiency under the premise of ensuring the reliability of UCI through reasonable parameter configuration.

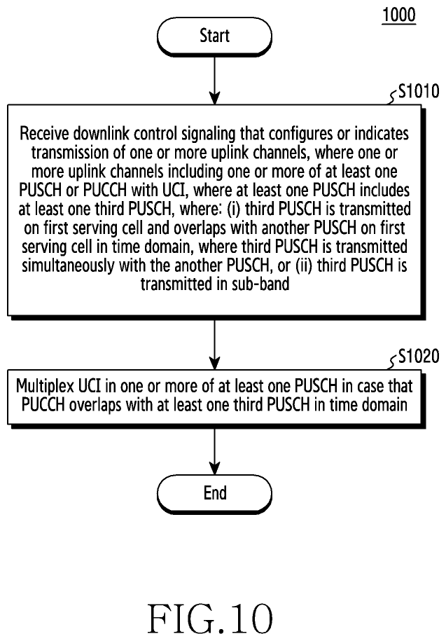

FIG. 10 illustrates a flowchart of a method 1000 performed by a terminal according to an embodiment of the disclosure.

Referring to FIG. 10, in operation S1010, the terminal receives downlink control signaling that configures or indicates transmission of one or more uplink channels, where the one or more uplink channels including one or more of at least one PUSCH or a PUCCH with UCI, where the at least one PUSCH includes at least one third PUSCH, where (i) the third PUSCH is transmitted on a first serving cell and overlaps with another PUSCH on the first serving cell in time domain, where the third PUSCH is transmitted simultaneously with the another PUSCH, or (ii) the third PUSCH is transmitted in a sub-band. For example, the terminal may receive the downlink control signaling from a base station.

Continuing to refer to FIG. 10, in operation S1020, the terminal multiplexes the UCI in one or more of the at least one PUSCH in case that the PUCCH overlaps with the at least one third PUSCH in time domain.

In some implementations, operations S1010 and/or S1020 may be performed based on the methods described according to various embodiments (e.g., various manners described above, such as manners MN1-MN14) of the disclosure.

In some implementations, the method 1000 may omit one or more of operation S1010 or operation S1020, or may include additional operations, for example, the operations performed by the terminal (e.g., a UE) that are described according to various embodiments (e.g., various manners described above, such as manners MN1-MN14) of the disclosure.

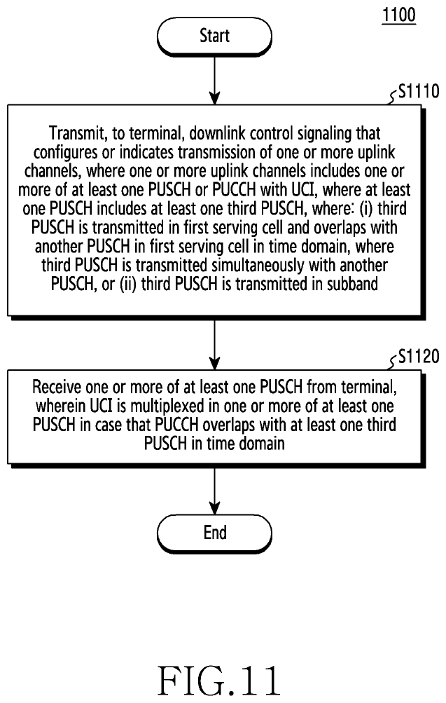

FIG. 11 illustrates a flowchart of a method 1100 performed by a base station according to an embodiment of the disclosure.

Referring to FIG. 11, in operation S1110, the base station transmits, to a terminal, downlink control signaling that configures or indicates transmission of one or more uplink channels including one or more of at least one PUSCH or a PUCCH, wherein the PUCCH carries UCI, and the at least one PUSCH includes at least one third PUSCH, wherein: (i) the third PUSCH is transmitted on a first serving cell and overlaps with another PUSCH on the first serving cell in time domain, wherein the third PUSCH is transmitted simultaneously with the another PUSCH; or (ii) the third PUSCH is transmitted in a sub-band.

Continuing to refer to FIG. 11, in operation S1120, the base station receives one or more of the at least one PUSCH from the terminal, wherein the UCI is multiplexed in the one or more of the at least one PUSCH in case that the PUCCH overlaps with the at least one third PUSCH in time domain.

In some implementations, operations S1110 and/or S1120 may be performed based on the methods described according to various embodiments (e.g., various manners described above, such as manners MN1-MN14) of the disclosure.

In some implementations, the method 1100 may omit one or more of operation S1110 or operation S1120, or may include additional operations, for example, the operations performed by the base station that are described according to various embodiments (e.g., various manners described above, such as manners MN1-MN14) of the disclosure.

In an embodiment of the disclosure, a method performed by a terminal in a wireless communication system, comprising: receiving downlink control signaling that configures or indicates transmission of one or more uplink channels, wherein the one or more uplink channels includes one or more of at least one physical uplink shared channel (PUSCH) or a physical uplink control channel (PUCCH), wherein the PUCCH carries uplink control information (UCI), and the at least one PUSCH includes at least one third PUSCH, wherein, the third PUSCH is transmitted on a first serving cell, and the third PUSCH overlaps with another PUSCH on the first serving cell in a time domain, wherein the third PUSCH is transmitted simultaneously with the another PUSCH, or the third PUSCH is transmitted in a sub-band; and multiplexing the UCI in one or more of the at least one PUSCH, in case that the PUCCH overlaps with the at least one third PUSCH in the time domain.

In an embodiment of the disclosure, further comprising receiving one or more of first configuration information or second configuration information, wherein the first configuration information indicates a control resource set (CORESET) pool index, and the second configuration information indicates a sounding reference signal (SRS) resource set index, wherein the multiplexing the UCI in one or more of the at least one PUSCH includes: multiplexing the UCI in one of the at least one PUSCH based on the one or more of the first configuration information or the second configuration information.

In an embodiment of the disclosure, wherein the multiplexing the UCI in one of the at least one PUSCH based on the one or more of the first configuration information or the second configuration information includes one of: multiplexing the UCI in one of the at least one PUSCH that is associated with a first value of the CORESET pool index or the SRS resource set index; or multiplexing the UCI in one of the at least one PUSCH that is associated with a second value of the CORESET pool index or the SRS resource set index, wherein the second value is greater than the first value.

In an embodiment of the disclosure, wherein the at least one PUSCH further includes at least one fourth PUSCH, wherein, the fourth PUSCH is transmitted on a second serving cell, and the fourth PUSCH is not transmitted simultaneously with another PUSCH on the second serving cell, or the fourth PUSCH is transmitted in a full bandwidth, wherein the multiplexing the UCI in one of the at least one PUSCH based on the one or more of the first configuration information or the second configuration information includes one of: multiplexing the UCI in one of the at least one third PUSCH that is associated with a first value of the CORESET pool index or the SRS resource set index, multiplexing the UCI in one of the at least one third PUSCH that is associated with a second value of the CORESET pool index or the SRS resource set index, wherein the second value is greater than the first value, multiplexing the UCI in one of the at least one fourth PUSCH that is associated with the first value of the CORESET pool index or the SRS resource set index, or multiplexing the UCI in one of the at least one fourth PUSCH that is associated with the second value of the CORESET pool index or the SRS resource set index.

In an embodiment of the disclosure, wherein the at least one PUSCH further includes at least one fourth PUSCH, wherein, the fourth PUSCH is transmitted on a second serving cell, and the fourth PUSCH is not transmitted simultaneously with another PUSCH on the second serving cell, or the fourth PUSCH is transmitted in a full bandwidth, wherein the multiplexing the UCI in one of the at least one PUSCH includes one of: multiplexing the UCI in one of the at least one third PUSCH, or multiplexing the UCI in one of the at least one fourth PUSCH.

In an embodiment of the disclosure, wherein the multiplexing the UCI in one or more of the at least one PUSCH in case that the PUCCH overlaps with the at least one third PUSCH in the time domain includes multiplexing the UCI in a PUSCH of the at least one PUSCH that has a same value of the CORESET pool index as the PUCCH, in case that the PUCCH overlaps with two third PUSCHs of the at least one PUSCH in the time domain, wherein the two third PUSCHs are on the first serving cell.

In an embodiment of the disclosure, wherein the multiplexing the UCI in one or more of the at least one PUSCH in case that the PUCCH overlaps with the at least one third PUSCH in the time domain includes multiplexing the UCI in two third PUSCHs of the at least one third PUSCH, in case that the PUCCH overlaps with the two third PUSCHs in the time domain, wherein the two third PUSCHs are on the first serving cell.

In an embodiment of the disclosure, further comprising receiving one or more of third configuration information or fourth configuration information, wherein the third configuration information indicates a number or scaling of resources on the third PUSCH that are allocated to the UCI when the UCI is multiplexed in the third PUSCH, and the fourth configuration information indicates a number or scaling of resources allocated to the UCI on a PUSCH when the UCI is multiplexed in the PUSCH.

In an embodiment of the disclosure, wherein when the UCI is multiplexed in the third PUSCH from the at least one PUSCH, a number of the resources allocated to the UCI on the third PUSCH is determined based on the third configuration information.

In an embodiment of the disclosure, when the UCI is multiplexed in the fourth PUSCH, a number of the resources allocated to the UCI on the fourth PUSCH is determined based on the fourth configuration information.

In an embodiment of the disclosure, wherein when the UCI is multiplexed in the third PUSCH from the at least one PUSCH, in case that the third configuration information is not provided, a number of the resources allocated to the UCI on the third PUSCH is determined based on the fourth configuration information.

In an embodiment of the disclosure, wherein when the terminal indicates a capability of multiplexing HARQ-ACK in a PUSCH when there is no PUCCH, and the terminal does not determine any PUCCH with HARQ-ACK information in a time unit where the at least one PUSCH is located and one or more of the at least one PUSCH is scheduled by a DCI format including a downlink assignment index (DAI) field, a PUSCH of the at least one PUSCH is determined as a candidate PUSCH for HARQ-ACK information multiplexing, other than one or more of a PUSCH scheduled by a DCI format that does not include a DAI field; a PUSCH not scheduled by a DCI format; a PUSCH configured or indicated with a transmission with repetitions, or a PUSCH of more than one PUSCH scheduled by a DCI format.

In an embodiment of the disclosure, wherein the third PUSCH is transmitted simultaneously with the another PUSCH based on one or more of receiving first configuration information that indicates at least two different values for a CORESET pool index, receiving second configuration information that indicates at least two different values for an SRS resource set index, or receiving fifth configuration information that indicates simultaneous transmission of two or more PUSCHs.

In an embodiment of the disclosure, a method performed by a base station in a wireless communication system, comprising transmitting, to a terminal, downlink control signaling that configures or indicates transmission of one or more uplink channels, wherein the one or more uplink channels includes one or more of at least one physical uplink shared channel (PUSCH) or a physical uplink control channel (PUCCH), wherein the PUCCH carries uplink control information (UCI), and the at least one PUSCH includes at least one third PUSCH, wherein, the third PUSCH is transmitted on a first serving cell, and the third PUSCH overlaps with another PUSCH on the first serving cell in the time domain, wherein the third PUSCH is transmitted simultaneously with the another PUSCH, or the third PUSCH is transmitted in a sub-band; and receiving, from the terminal, one or more of the at least one PUSCH, wherein the UCI is multiplexed in the one or more of the at least one PUSCH, in case that the PUCCH overlaps with the at least one third PUSCH in the time domain.

In an embodiment of the disclosure, a terminal in a wireless communication system, comprising a transceiver, and a controller coupled to the transceiver and configured to implement the steps of the method above.

In an embodiment of the disclosure, a base station in a wireless communication system, comprising a transceiver; and a controller coupled to the transceiver and configured to implement the steps of the method above.

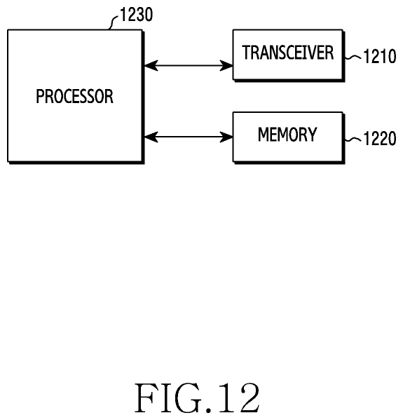

FIG. 12 illustrates a structure of a UE according to an embodiment of the disclosure.

Referring to FIG. 12, the UE according to an embodiment may include a transceiver 1210, memory 1220, and a processor 1230. The transceiver 1210, the memory 1220, and the processor 1230 of the UE may operate according to a communication method of the UE described above. However, the components of the UE are not limited thereto. For example, the UE may include more or fewer components than those described above. In addition, the processor 1230, the transceiver 1210, and the memory 1220 may be implemented as a single chip. In addition, the processor 1230 may include at least one processor. Furthermore, the UE of FIG. 12 corresponds to the UE 111, 112, 113, 114, 115, 116 of the FIG. 1, respectively.

The transceiver 1210 collectively refers to a UE receiver and a UE transmitter, and may transmit/receive a signal to/from a base station or a network entity. The signal transmitted or received to or from the base station or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

In addition, the transceiver 1210 may receive and output, to the processor 1230, a signal through a wireless channel, and transmit a signal output from the processor 1230 through the wireless channel.

The memory 1220 may store a program and data required for operations of the UE. In addition, the memory 1220 may store control information or data included in a signal obtained by the UE. The memory 1220 may be a storage medium, such as read-only memory (ROM), random access memory (RAM), a hard disk, a CD-ROM, and a DVD, or a combination of storage media.

The processor 1230 may control a series of processes such that the UE operates as described above. For example, the transceiver 1210 may receive a data signal including a control signal transmitted by the base station or the network entity, and the processor 3030 may determine a result of receiving the control signal and the data signal transmitted by the base station or the network entity.

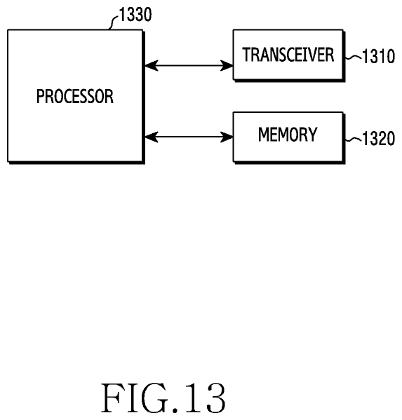

FIG. 13 illustrates a structure of a base station according to an embodiment of the disclosure.

Referring to FIG. 13, the base station according to an embodiment may include a transceiver 1310, memory 1320, and a processor 1330. The transceiver 1310, the memory 1320, and the processor 1330 of the base station may operate according to a communication method of the base station described above. However, the components of the base station are not limited thereto. For example, the base station may include more or fewer components than those described above. In addition, the processor 1330, the transceiver 1310, and the memory 1320 may be implemented as a single chip. In addition, the processor 1330 may include at least one processor. Furthermore, the base station of FIG. 13 corresponds to base station (e.g., BS 101, 102, 103 of FIG. 1).

The transceiver 1310 collectively refers to a base station receiver and a base station transmitter, and may transmit/receive a signal to/from a terminal(UE) or a network entity. The signal transmitted or received to or from the terminal or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

In addition, the transceiver 1310 may receive and output, to the processor 1330, a signal through a wireless channel, and transmit a signal output from the processor 1330 through the wireless channel.

The memory 1320 may store a program and data required for operations of the base station. In addition, the memory 1320 may store control information or data included in a signal obtained by the base station. The memory 1320 may be a storage medium, such as read-only memory (ROM), random access memory (RAM), a hard disk, a CD-ROM, and a DVD, or a combination of storage media.

The processor 1330 may control a series of processes such that the base station operates as described above. For example, the transceiver 1310 may receive a data signal including a control signal transmitted by the terminal, and the processor 1330 may determine a result of receiving the control signal and the data signal transmitted by the terminal.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any processor, controller, microcontroller, or state machine of the related art. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving first information for configuring simultaneous transmission of physical uplink shared channels (PUSCHs), second information for configuring at least one control resource set (CORESET) with a CORESET pool index, and third information for configuring ackNack feedback mode associated with uplink control information (UCI);
identifying a PUSCH to be used for multiplexing the UCI among the PUSCHs;
multiplexing the UCI in the identified PUSCH; and
transmitting the PUSCHs including the identified PUSCH in which the UCI is multiplexed,
wherein in case that the simultaneous transmission is enabled, the ackNack feedback mode is configured to a first mode, and the UCI includes Hybrid Automatic Repeat request-Acknowledgement (HARQ-ACK) information:
the identified PUSCH is one of candidate PUSCHs selected among the PUSCHs,
the identified PUSCH is associated with CORESETs which is same with CORESETs for transmission of a physical uplink control channel (PUCCH) with the HARQ-ACK information, and
the PUSCHs is transmitted based on the simultaneous transmission.

2. The method of claim 1, wherein in case that the simultaneous transmission is enabled, the ackNack feedback mode is configured to a second mode, the simultaneous transmission of the PUSCHs is performed in a slot that starts at a same symbol on a serving cell with a smallest cell index, and UCI multiplexing conditions are satisfied:
the identified PUSCH is one of the PUSCHs,
the PUSCHs are associated with CORESETs with a first CORESET pool index whose value is 0, and
the PUSCHs is transmitted based on the simultaneous transmission.

3. The method of claim 1, wherein in case that the PUSCHs is transmitted in a slot that starts at a same symbol on a serving cell with a smallest cell index, and UCI multiplexing conditions are satisfied, the identified PUSCH is an earliest PUSCH in a time domain among the PUSCHs.

4. The method of claim 2, wherein the CORESET pool index includes at least one of the first CORESET pool index whose value is 0 or a second CORESET pool index whose value is 1.

5. The method of claim 1, wherein the PUSCHs overlap with the PUCCH on which the UCI is transmitted.

6. A method performed by a base station in a wireless communication system, the method comprising:
transmitting, to a user equipment (UE), first information for configuring simultaneous transmission of physical uplink shared channels (PUSCHs), second information for configuring at least one control resource set (CORESET) with a CORESET pool index, and third information for configuring ackNack feedback mode associated with uplink control information (UCI); and
receiving, from the UE, the PUSCHs including a PUSCH in which the UCI is multiplexed,
wherein in case that the simultaneous transmission is enabled, the ackNack feedback mode is configured to a first mode, the UCI includes Hybrid Automatic Repeat request-Acknowledgement (HARQ-ACK) information:
the PUSCH is one of candidate PUSCHs selected among the PUSCHs,
the PUSCH is associated with CORESETs which is same with CORESETs for transmission of a physical uplink control channel (PUCCH) with the HARQ-ACK information, and
the PUSCHs is received based on the simultaneous transmission.

7. The method of claim 6, wherein in case that the simultaneous transmission is enabled, the ackNack feedback mode is configured to a second mode, the simultaneous transmission of the PUSCHs is performed in a slot that starts at a same symbol on a serving cell with a smallest cell index, and UCI multiplexing conditions are satisfied:
the PUSCH is one of the PUSCHs,
the PUSCHs are associated with CORESETs with a first CORESET pool index whose value is 0, and
the PUSCHs is transmitted based on the simultaneous transmission.

8. The method of claim 6, wherein in case that the PUSCHs is transmitted in a slot that starts at a same symbol on a serving cell with a smallest cell index, and UCI multiplexing conditions are satisfied, the identified PUSCH is an earliest PUSCH in a time domain among the PUSCHs.

9. The method of claim 7, wherein the CORESET pool index includes at least one of the first CORESET pool index whose value is 0 or a second CORESET pool index whose value is 1.

10. The method of claim 6, wherein the PUSCHs overlap with the PUCCH on which the UCI is transmitted.

11. A user equipment (UE) in a wireless communication system, the UE comprising:
a transceiver; and
a controller coupled with the transceiver and configured to:
receive first information for configuring simultaneous transmission of physical uplink shared channels (PUSCHs), second information for configuring at least one control resource set (CORESET) with a CORESET pool index, and third information for configuring ackNack feedback mode associated with uplink control information (UCI),
identify a PUSCH to be used for multiplexing the UCI among the PUSCHs,
multiplex the UCI in the identified PUSCH, and
transmit the PUSCHs including the identified PUSCH in which the UCI is multiplexed,
wherein in case that the simultaneous transmission is enabled, the ackNack feedback mode is configured to a first mode, and the UCI includes Hybrid Automatic Repeat request-Acknowledgement (HARQ-ACK) information:
the identified PUSCH is one of candidate PUSCHs selected among the PUSCHs,
the identified PUSCH is associated with CORESETs which is same with CORESETs for transmission of a physical uplink control channel (PUCCH) with the HARQ-ACK information, and
the PUSCHs is transmitted based on the simultaneous transmission.

12. The UE of claim 11, wherein in case that the simultaneous transmission is enabled, the ackNack feedback mode is configured to a second mode, the simultaneous transmission of the PUSCHs is performed in a slot that starts at a same symbol on a serving cell with a smallest cell index, and UCI multiplexing conditions are satisfied:
the identified PUSCH is one of the PUSCHs,
the PUSCHs are associated with CORESETs with a first CORESET pool index whose value is 0, and
the PUSCHs is transmitted based on the simultaneous transmission.

13. The UE of claim 11, wherein in case that the PUSCHs is transmitted in a slot that starts at a same symbol on a serving cell with a smallest cell index, and UCI multiplexing conditions are satisfied, the identified PUSCH is an earliest PUSCH in a time domain among the PUSCHs.

14. The UE of claim 12, wherein the CORESET pool index includes at least one of the first CORESET pool index whose value is 0 or a second CORESET pool index whose value is 1.

15. The UE of claim 11, wherein the PUSCHs overlap with the PUCCH on which the UCI is transmitted.

16. A base station in a wireless communication system, the base station comprising:
a transceiver; and
a controller coupled with the transceiver and configured to:
transmit, to a user equipment (UE), first information for configuring simultaneous transmission of physical uplink shared channels (PUSCHs), second information for configuring at least one control resource set (CORESET) with a CORESET pool index, and third information for configuring ackNack feedback mode associated with uplink control information (UCI), and
receive, from the UE, the PUSCHs including a PUSCH in which the UCI is multiplexed,
wherein in case that the simultaneous transmission is enabled, the ackNack feedback mode is configured to a first mode, and the UCI includes Hybrid Automatic Repeat request-Acknowledgement (HARQ-ACK) information:
the PUSCH is one of candidate PUSCHs selected among the PUSCHs,
the PUSCH is associated with CORESETs which is same with CORESETs for transmission of a physical uplink control channel (PUCCH)with the HARQ-ACK information, and
the PUSCHs is received based on the simultaneous transmission.

17. The base station of claim 16, wherein in case that the simultaneous transmission is enabled, the ackNack feedback mode is configured to a second mode, the simultaneous transmission of the PUSCHs is performed in a slot that starts at a same symbol on a serving cell with a smallest cell index, and UCI multiplexing conditions are satisfied:
the PUSCH is one of the PUSCHs,
the PUSCHs are associated with CORESETs with a first CORESET pool index whose value is 0, and
the PUSCHs is transmitted based on the simultaneous transmission.

18. The base station of claim 16, wherein in case that the PUSCHs is transmitted in a slot that starts at a same symbol on a serving cell with a smallest cell index, and UCI multiplexing conditions are satisfied, the identified PUSCH is an earliest PUSCH in a time domain among the PUSCHs.

19. The base station of claim 17, wherein the CORESET pool index includes at least one of the first CORESET pool index whose value is 0 or a second CORESET pool index whose value is 1.

20. The base station of claim 16, wherein the PUSCHs overlap with the PUCCH on which the UCI is transmitted.
